(19) United States
(12) Patent Application Publication
(10) Pub. No.: US 2008/0170687 A1
(43) Pub. Date: Jul. 17, 2008

(54) Device for and a Method of Processing an Encrypted Data Stream

(75) Inventors: Eric Moors, Someren (NL); Roland Manders, Horst (NL); Albert Rijckaert, Waalre (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/912,323

(22) PCT Filed: Apr. 25, 2006
(86) PCT No.: PCT/IB06/51280

§ 371 Date: Oct. 23, 2007

(30) Foreign Application Priority Data
Apr. 26, 2005 (EP) 05103397.5

(51) Int. Cl. H04N 7/167; H04L 9/00

(52) U.S. Cl. 380/200; 380/42

(57) ABSTRACT

A device (3000) for processing an encrypted data stream (3001), wherein decryption messages are provided for decrypting each segment (1403) of the encrypted data stream (3001), wherein each decryption message comprises a number of decryption elements, wherein the device (3000) comprises a detection unit (3002) for detecting the number of decryption elements per decryption message, and a determining unit (3003) for determining a position for providing the decryption messages in relation to the sequence of the segments (1403), based on the detected number.

### FIELD OF THE INVENTION

The invention relates to a device for processing an encrypted data stream.

Beyond this, the invention relates to a method of processing an encrypted data stream.

Moreover, the invention relates to a program element.

Furthermore, the invention relates to a computer-readable medium.

### BACKGROUND OF THE INVENTION

Electronic entertainment devices become more and more important. Particularly, an increasing number of users buy hard disk based audio/video players and other entertainment equipment.

Since the reduction of storage space is an important issue in the field of audio/video players, audio and video data are often stored in a compressed manner, and for security reasons in an encrypted manner.

MPEG2 is a standard for the generic coding of moving pictures and associated audio and creates a video stream out of frame data that can be arranged in a specified order called the GOP (“Group Of Pictures”) structure. An MPEG2 video bitstream is made up of a series of data frames encoding pictures. The three ways of encoding a picture are intra-coded (I picture), forward predictive (P picture) and bidirectional predictive (B picture). An intra-coded frame (I-frame) is related to a particular picture and contains the corresponding data. A forward predictive frame (P-frame) needs information of a preceding I-frame or P-frame. A bidirectional predictive frame (B-frame) is dependent on information of a preceding or subsequent I-frame or P-frame.

It is an interesting function in a media playback device to switch from a normal reproduction mode, in which media content is played back in a normal speed, to a trick-play reproduction mode, in which media content is played back in a modified manner, for instance with an increased speed (“fast forward”), or vice versa.

WO 03/107666 A1 discloses trick-play on an encrypted data stream, wherein units of Control Word information required to decrypt successive segments of the stream are supplied.

Different media content providers may use different formats for encrypted video content and for decryption data needed for decrypting the encrypted video content. Thus, the coordination of providing segments of encrypted video content and providing and decrypting encrypted decryption data may be difficult, particularly at a transition between normal-play and trick-play.

### OBJECT AND SUMMARY OF THE INVENTION

It is an object of the invention to properly adjust the provision of an encrypted data stream and corresponding decryption data.

In order to achieve the object defined above, a device for processing an encrypted data stream, a method of processing an encrypted data stream, a program element and a computer-readable medium according to the independent claims are provided.

According to an exemplary embodiment of the invention, a device for processing an encrypted data stream is provided, wherein decryption messages are provided for decrypting each segment of the encrypted data stream, wherein each decryption message comprises a number of decryption elements, wherein the device comprises a detection unit for detecting the number of decryption elements per decryption message, and a determining unit for determining a position for providing the decryption messages in relation to the sequence of the segments, based on the detected number.

According to another exemplary embodiment of the invention, a method of processing an encrypted data stream is provided, wherein decryption messages are provided for decrypting each segment of the encrypted data stream, wherein each decryption message comprises a number of decryption elements, wherein the method comprises the steps of detecting the number of decryption elements per decryption message, and determining a position for providing the decryption messages in relation to the sequence of the segments, based on the detected number.

According to still another exemplary embodiment of the invention, a device for processing an encrypted data stream is provided, wherein decryption messages are provided for decrypting each segment of the encrypted data stream, wherein the device comprises a detection unit for detecting a switch from a trick-play reproduction mode to a normal play reproduction mode, and a determining unit for determining a manner of handling the decryption messages to avoid an excessive interruption of reproduction when switching from the trick-play reproduction mode to the normal play reproduction mode.

Moreover, according to yet another exemplary embodiment of the invention, a method of processing an encrypted data stream is provided, wherein decryption messages are provided for decrypting each segment of the encrypted data stream, wherein the method comprises the steps of detecting a switch from a trick-play reproduction mode to a normal play reproduction mode, and determining a manner of handling the decryption messages to avoid an excessive interruption of reproduction when switching from the trick-play reproduction mode to the normal play reproduction mode.

Beyond this, according to another exemplary embodiment of the invention, a computer-readable medium is provided, in which a computer program is stored, which computer program, when being executed by a processor, is adapted to control or carry out any of the above-mentioned methods.

Moreover, according to still another exemplary embodiment of the invention, a program element is provided, which program element, when being executed by a processor, is adapted to control or carry out any of the above-mentioned methods.

The data processing according to the invention can be realized by a computer program, that is to say by software, or by using one or more special electronic optimization circuits, that is to say in hardware, or in hybrid form, that is to say by means of software components and hardware components.

The characterizing features according to the invention particularly have the advantage that encrypted content and corresponding (optionally decrypted) decryption data needed for decrypting the encrypted content may be properly synchronized due to sophisticatedly controlling the provision and the handling of the decryption messages, in particular Entitlement Control Messages (ECM). By choosing a position or time suitable for inserting or providing a particular decryption message in a data stream may ensure that sufficient and correct information for decrypting the decryption messages and/or the encrypted data stream is delivered in due time. Particularly the number of decryption elements (for instance Control Words) included in a decryption message (for instance an ECM) may contain valuable information for improving synchronization. By taking this measure, decryption data may be provided sufficiently early to ensure that a reproduction of the data stream in any reproduction mode (for instance normal play or trick-play) is continuous without disturbing long interruptions of reproduction. Particularly at a transition from trick-play to normal play, it may be advantageous to properly extract, select and/or process decryption information delivered with a data stream to allow accurate and timely decryption to avoid or minimize an interruption in a transition area.

According to one aspect of the invention, a number of decryption elements (for instance Control Words) included in a single decryption message (for instance an ECM) may be used as a criteria for controlling the timing of delivery of decryption messages. Then, this detected number may be taken as a basis for deciding at which position a decryption message should be inserted in a sequence of segments forming the data stream. In dependence of the number of decryption elements per decryption message, for instance one or two, it may be appropriate to provide the corresponding decryption messages in a particular time in advance or not, for instance one segment in advance or zero segments in advance. By properly choosing this position, it is possible to improve or optimize the synchronization of the provision of content data and decryption data.

Thus, according to an exemplary embodiment of the invention, a method for Entitlement Control Message handling, particularly in fast forward mode (as an example for a trick-play reproduction mode), is provided. In case of such a fast forward trick-play mode, ECMs and Control Words (CW), respectively, may be delivered a particular period in advance (particularly in the current period or one period in advance), depending on the amount of CWs in the periods (for instance one or two). It may also be possible to (temporarily) buffer and/or file and/or (permanently) store the ECMs.

To create a trick-play stream, it might be appropriate that data blocks are supplied to a decrypter. Such a decrypter needs Control Words used in the encryption process to decrypt the data blocks. These Control Words may be also encrypted and stored in an Entitlement Control Message (ECM). There may be an implicit upper trick-play speed limit, originating from the limited speed of the processing capability of the decryption message decrypter (for instance a smartcard). In normal play, the Control Word lifetime may be 10 seconds and may be compressed with the trick-play speed factor in trick-play mode.

According to one embodiment of the invention, a method of generating a trick-play stream of an encrypted video data stream is provided. At least one Control Word may be required for decrypting successive segments of the video data stream, the Control Words being supplied in an Entitlement Control Message (ECM), the Entitlement Control Message (ECM) being provided in advance of the successive segment of the video data stream to be decrypted. The method may comprise the steps of detecting whether a single Control Word or more Control Words are provided (per ECM). Subsequently, for decryption, a current Entitlement Control Message (ECM) may be provided in case the Entitlement Control Message holds two Control Words (CWs), else providing an Entitlement Control Message (ECM) one period in advance if it holds only a single Control Word (CW). Optionally, originally provided Entitlement Control Messages may be removed from the encrypted video data stream. Consequently, an improved, correctly performed trick-play mode, in particular fast forward trick-play mode, may be achieved.

For ECMs to be available for trick-play at a correct moment, the ECMs may be stored in a separate file. In this file, it may be possible to indicate to which period an ECM belongs.

Exemplary fields of application of the system according to the invention are digital video recording devices (such as harddisk combinations, DVD+RW, etc.), network enabled devices using trick-play, or conditional access systems.

The system according to an exemplary embodiment of the invention addresses to special ECM precautions. It has been discovered that these precautions may be advantageous in many cases in fast-forward trick-play. Improved insight in this matter has shown that a refinement of such precautions may be appropriate to correctly perform trick-play, particularly fast-forward trick-play.

According to another aspect of the invention, a proper synchronization of decryption messages and content to be reproduced at a transition from trick-play to normal play may be achieved by detecting a switch between these two reproduction modes. When such a switch occurs, a determining unit may ensure that an interruption of reproduction is avoided or at least significantly reduced around the switch by properly analyzing decryption messages, controlling their provision and/or selecting appropriate decryption messages. Particularly, a last decryption message sent before the start of the trick-play reproduction mode and a first decryption message sent after the end of the trick-play reproduction mode may be analyzed or compared in this context. In particular, it may be decided whether extracting or processing of the first decryption message in the started normal play mode is necessary or not. Thus, the quality of a trick-play/normal play transition may be improved and undesired switching effects may be suppressed. Thus, it may be ensured that, when switching from a plaintext trick-play stream to an encrypted normal play stream, a correct decryption start occurs as soon as possible. In other words, the required and the correct ECMs may be provided as fast as possible after the switch.

Referring to the dependent claims, further exemplary embodiments of the invention will be described.

Next, exemplary embodiments of the device for processing an encrypted data stream detecting the number of decryption elements per decryption message will be described. These embodiments may also be applied for the method of processing an encrypted data stream, for the computer-readable medium and for the program element.

The decryption messages may be Entitlement Control Messages (ECMs), and the decryption elements may be Control Words (CW). Accordingly, the device may be realized as an MPEG2 video data processing device.

According to another exemplary embodiment of the invention, a decryption message corresponding to a particular segment may be provided in advance of the particular segment. By providing the decryption message in good time before the beginning of a particular segment, it may be ensured that the decryption message itself can be decrypted before the corresponding segment of content data shall be reproduced. Such a reproduction may require the completion of the decryption of the corresponding (part of the) segment using the decrypted decryption message.

The determining unit of the device may be adapted to, in case that the detected number of decryption elements per decryption message is two, provide the decryption message zero segments in advance. In other words, the decryption message may be delivered essentially directly preceding the corresponding segment. Thus, when two CWs are provided in an ECM for a corresponding period of the data stream, the ECM does not have to be sent with a distance in advance. For instance, for a particular segment or period, it may be possible to provide the decryption elements for this period and for a subsequent period in a common decryption message. In the next period, again the decryption element for this period may be provided, and in addition to this the corresponding decryption element for the next period. This scheme may allow to provide all the decryption elements (Control Words) in due time so that a long interruption can be avoided when reproducing data related to different periods.

However, in the case that the detected number of decryption elements per decryption message is one, the determining unit of the device may be adapted to provide the decryption message one segment in advance. This may ensure a proper synchronisation of content and decryption data.

The device may further comprise a storage unit which may be adapted to store the decryption messages in a separate file. This file may be indicative of the assignment of the decryption messages to the corresponding segments. By storing decryption messages assigned to corresponding segments in a separate data file, the decryption data may be archived and can be easily retrieved, when needed.

Particularly, two registers may be provided for storing the two decryption elements of a single decryption message, wherein only one of the two registers is capable of overwriting data stored therein at a time. In other words, the decrypter may contain two registers, one for so-called “odd” and one for so-called “even” decryption elements, so that two types of decryption elements may be defined. “Odd” and “even” are terms for distinguishing between two subsequent decryption elements in a stream. One of the two registers stores the even decryption elements, the other one stores the odd decryption elements. After decryption, the decryption elements may be written to the corresponding registers in the decrypter, possibly overwriting previously stored values. However, only a currently inactive register may be overwritten with a new value.

The device may comprise a control unit adapted to remove originally provided decryption messages from the encrypted data stream, particularly in order to prevent a possible overwrite of decryption elements in the registers that are still needed. The device may be adapted to process an encrypted data stream of video data or audio data. However, such media content is not the only type of data that may be processed with the scheme according to the invention. Trick-play generation and similar applications may be an issue for both, video processing and (pure) audio processing.

The device may further be adapted to process an encrypted data stream of digital data.

Furthermore, the device may comprise a reproduction unit for reproducing the decrypted data stream. Such a reproduction unit may comprise a loudspeaker or earphones and/or an optical display device so that both, audio and visual data can be reproduced perceivable for a human being.

Moreover, the device may comprise a generation unit for processing the decrypted data stream for reproduction in a trick-play reproduction mode. Such a trick-play generation unit adapted to generate a data stream for reproduction in a trick-play reproduction mode may be adjusted by a user by selecting corresponding options in a user interface, for instance buttons of a device, a keypad or a remote control. The trick-play reproduction mode selected by a user may be one of the group consisting of a fast forward reproduction mode, a fast reverse reproduction mode, a slow motion reproduction mode, a freeze frame reproduction mode, an instant replay reproduction mode, and a reverse reproduction mode. Other trick-play streams are however possible. For trick-play, only a portion of subsequent data shall be used for output (for instance for visual display and/or for acoustical output). Since not all data (P-frames, B-frames) in a data stream can be used independently from other data (I-frames) for generating displayable signals, the knowledge of independently usable data (I-frames) may be of interest.

The device according to the invention may be adapted to process an encrypted MPEG2 data stream. MPEG2 is a designation for a group of audio and video coding standards agreed upon by MPEG (Moving Pictures Experts Group), and published as the ISO/IEC 13818 International Standard. For example, MPEG2 is used to encode audio and video for broadcast signals including digital satellite and cable TV, but may also be used for DVD.

The device according to the invention may be realized as one of the group consisting of a digital video recording device, a network-enabled device, a conditional access system, a portable audio player, a portable video player, a mobile phone, a DVD player, a CD player, a harddisk-based media player, an internet radio device, a public entertainment device, and an MP3 player. However, these applications are only exemplary.

Next, exemplary embodiments of the device for processing an encrypted data stream based on a detection of a switch from a trick-play reproduction mode to a normal play reproduction mode will be described. These embodiments may be applied for the method of processing an encrypted data stream, for the computer-readable medium and for the program element.

In the device, the determining unit may be adapted for determining, based on a last decryption message before the trick-play reproduction mode and a first decryption message in the normal play reproduction mode, whether the first decryption message in the normal play reproduction mode is to be modified. The combination of the last decryption message before the trick-play reproduction and the first decryption message after the trick-play reproduction mode may contain information required for securely deciding in which way these decryption messages are to be used to ensure a proper processing without a disturbing long interruption. Particularly, this analysis may be directed to the question whether the first decryption message in the normal play mode should be modified to make sure that the decryption element(s) included therein are used in order to reduce a gap between trick-play and normal play.

More particularly, the determining unit may be adapted for determining, based on a comparison of a last decryption message before the trick-play reproduction mode and a first decryption message in the normal play reproduction mode, whether the first decryption message in the normal play reproduction mode is to be modified. Such a comparison, particularly of the type of decryption messages, may improve the quality of the transition from trick-play to normal play. By a comparison of the last decryption message before the trick-play reproduction mode and the first decryption message in the normal play reproduction mode, it may be possible to estimate the length of the interruption when a switch between reproduction modes occurs. It may be possible to reduce the length of this interruption by taking proper countermeasures. The necessity to process (particularly to decrypt and use) the first decryption message in the normal play reproduction mode may be used to reduce or eliminate such an interruption.

The determining unit may be adapted for determining that the system may be brought into an operation state in which the first encountered decryption message of the normal play mode will be sent to a decryption message processor, if no decryption messages are present in the stream for more than a threshold time interval of, for instance several seconds. In other words, particularly to avoid an excessive switching time from trick-play to normal play, it is possible to introduce a timeout functionality for ECMs.

Additionally or alternatively, the determining unit may be adapted for determining that the first decryption message in the normal play reproduction mode is to be modified when the comparison yields the result that decryption message types of the last decryption message before the trick-play reproduction mode and the first decryption message in the normal play reproduction mode (that is after the trick-play reproduction mode) are identical. According to this embodiment, the system may be forced to use the first ECM of the normal play stream. When a switch to normal play has occurred, the type of the last ECM before switching to trick-play, which has been remembered, may be compared to the type of the first ECM in the normal play stream. If identical, the type of the first ECM in the normal play stream is corrected in such a way that it is guaranteed that this ECM is processed by the smartcard.

Additionally or alternatively, the determining unit may be adapted for adding a last decryption message, which is a copy of the first decryption message in the normal play reproduction mode but with a decryption message type opposite to the remembered one, to an end of the data stream in the trick-play reproduction mode when a switch from the trick-play reproduction mode to the normal play reproduction mode is detected. According to this embodiment, an ECM may be added at the end of the trick-play stream at the moment the switching command is received. From the ECM file, it may be known what the first ECM of the normal play stream will be. This ECM may then be inserted at the end of the trick-play stream, particularly with a type opposite to the remembered one. Additionally or alternatively, the determining unit may be adapted for adding at least one decryption message within the data stream in the trick-play reproduction mode. Particularly, the determining unit according to this embodiment may be adapted for copying decryption messages from originally encrypted intra-coded frames within the data stream in the trick-play reproduction mode. Thus, ECMs may be inserted in the trick-play stream by a trick-play generator. Although not necessary for processing of the plaintext trick-play data by a receiver, taking this measure does not disturb the processing either. On the other hand, it may prevent the ECM interruption by keeping the ECM stream going.

Still referring to the described embodiment, the determining unit may be adapted for copying decryption messages from originally encrypted intra-coded frames within the data stream in the trick-play reproduction mode. Additionally or alternatively, the adding unit may be adapted for inserting decryption messages, used for generating the data stream in the trick-play reproduction mode, within the data stream in the trick-play reproduction mode. In other words, the first option is related to embedding ECMs present in the originally encrypted I-frames that may simply be copied to the trick-play stream. The second option is to insert the ECMs that are used for the trick-play generation.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a time-stamped transport stream packet.

FIG. 2 shows an MPEG2 group of picture structure with intra-coded frames and forward predictive frames.

FIG. 3 illustrates an MPEG2 group of picture structure with intra-coded frames, forward predictive frames and bidirectional predictive frames.

FIG. 4 illustrates a structure of an characteristic point information file and stored stream content.

FIG. 5 illustrates a system for trick-play on a plaintext stream.

FIG. 6 illustrates time compression in trick-play.

FIG. 7 illustrates trick-play with fractional distance.

FIG. 8 illustrates low speed trick-play.

FIG. 9 illustrates a general conditional access system structure.

FIG. 10 illustrates a digital video broadcasting encrypted transport stream packet.

FIG. 11 illustrates a transport stream packet header of the digital video broadcasting encrypted transport stream packet of FIG. 10.

FIG. 12 illustrates a system allowing to perform trick-play on a fully encrypted stream.

FIG. 13 illustrates a full transport stream and a partial transport stream.

FIG. 14 illustrates Entitlement Control Messages for a stream type I and for a stream type II.

FIG. 15 illustrates writing Control Words to a decrypter.

FIG. 16 illustrates Entitlement Control Message handling in a fast forward mode.

FIG. 17 illustrates detection of one or two Control Words.

FIG. 18 illustrates jumping across two Scrambling Control Bit toggles.

FIG. 19 illustrates Entitlement Control Message handling in a fast forward trick-play mode.

FIG. 20 illustrates Entitlement Control Message handling in a moderate fast forward play mode.

FIG. 21 illustrates a trick-play generator and a receiver according to an exemplary embodiment of the invention.

FIG. 22 illustrates Entitlement Control Message interruption during trick-play.

FIG. 23 illustrates changing the table ID of a first normal play Entitlement Control Message.

FIG. 24 illustrates an additional Entitlement Control Message at the end of trick-play.

FIG. 25 illustrates switching from forward trick-play to normal play.

FIG. 26 illustrates switching from reverse trick-play to normal play.

FIG. 27 illustrates switching from forward to normal play.

FIG. 28 illustrates optimized switching from trick-play to normal play.

FIG. 29 illustrates a common decrypter for trick-play generator and receiver.

FIG. 30 illustrates a device for processing an encrypted data stream according to an exemplary embodiment of the invention.

FIG. 31 illustrates another device for processing an encrypted data stream according to another exemplary embodiment of the invention.

FIG. 32 shows an example of an ECM file.

### DESCRIPTION OF EMBODIMENTS

The illustration in the drawing is schematically. In different drawings, similar or identical elements are provided with the same reference signs.

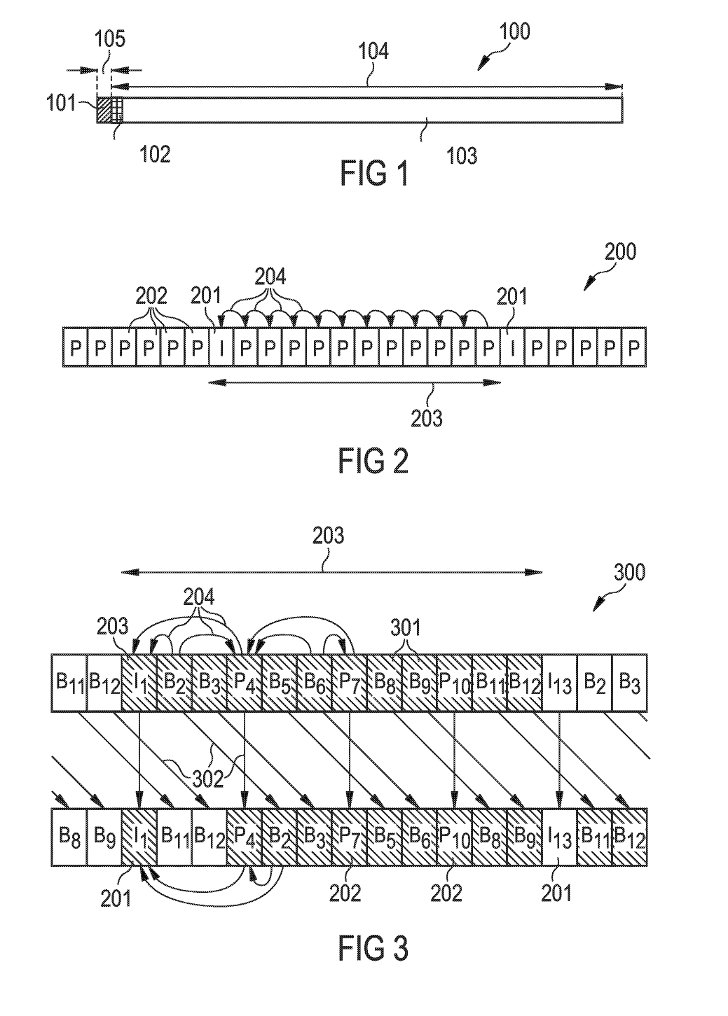

In the following, referring to FIG. 1 to FIG. 13, different aspects of trick-play implementation for transport streams according to exemplary embodiments of the invention will be described.

Particularly, several possibilities to perform trick-play on an MPEG2 encoded stream will be described, which may be partly or totally encrypted, or non-encrypted. The following description will target methods specific to the MPEG2 transport stream format. However, the invention is not restricted to this format.

Experiments were actually done with an extension, the so-called time-stamped transport stream. This comprises transport stream packets, all of which are pre-pended with a 4 bytes header in which the transport stream packet arrival time is placed. This time may be derived from the value of the program clock reference (PCR) time-base at the time the first byte of the packet is received at the recording device. This is a proper method to store the timing information with the stream, so that playback of the stream becomes a relatively easy process.

One problem during playback is to ensure that the MPEG2 decoder buffer will not overrun nor underflow. If the input stream was compliant to the decoder buffer model, restoring the relative timing ensures that the output stream is also compliant. Some of the trick-play methods described herein are independent of the time stamp and perform equally well on transport streams with and without time stamps.

FIG. 1 illustrates a time stamped transport stream packet 100 having a total length 104 of 188 Bytes and comprising a time stamp 101 having a length 105 of 4 Bytes, a packet header 102, and a packet payload 103 having a length of 184 Bytes.

This following description will give an overview of the possibilities to create an MPEG/DVB (digital video broadcasting) compliant trick-play stream from a recorded transport stream and intends to cover the full spectrum of recorded streams from those that are completely plaintext, so every bit of data can be manipulated, to streams that are completely encrypted (for instance according to the DVB scheme), so that only headers and some tables may be accessible for manipulation. The invention also addresses a solution in between these extremes, where only the data that needs to be manipulated to generate the trick-play stream is in plaintext.

When creating trick-play for an MPEG/DVB transport stream, problems may arise when the content is at least partially encrypted. It may not be possible to descend to the elementary stream level, which is the usual approach, or even access any packetized elementary stream (PES) headers before decryption. This also means that finding picture frames is not possible. Known trick-play engines need to be able to access and process this information.

In the frame of this description, the term “ECM” denotes an Entitlement Control Message. This message may particularly comprise a secret provider proprietary information and may, among others, contain encrypted Control Words (CW) needed to decrypt the MPEG stream. Typically, Control Words expire in 10-20 seconds. The ECMs are embedded in packets in the transport stream.

In the frame of this description, the term “keys” particularly denotes data which may be stored in a smartcard and may be transferred to the smartcard using EMMs, that is so-called “Entitlement Management Messages” that may be embedded in the transport stream. These keys may be used by the smartcard to decrypt the Control Words present in the ECM. An exemplary validity period of such a key is one month.

In the frame of this description, the term “Control Words” (CW) particularly denotes decryption information needed to decrypt actual content. Control words may be decrypted by the smartcard and then stored in a memory of the decryption core.

In the following, some aspects related to trick-play on plaintext streams will be described.

Even if an MPEG2 stream is not encrypted (that is to say plaintext), trick-play is not trivial. An easy solution is just to output the data faster to a decoder to get a fast-forward mode, but as MPEG has timing related information encoded in its headers, this cannot just be done with the expectation to get a proper fast-forward. Besides that, it may be difficult to decide what frames to drop, as this method to perform fast-forward, may give a frame rate higher than the display rate.

Moreover, such a stream is not an MPEG2 compliant transport stream. This can be acceptable if the decoder is in the storage device but may be problematic if the signal is transferred by a standard digital interface. Furthermore, the bit rate may increase dramatically in the whole chain. If the normal play stream is a time stamped transport stream of a single program originating from satellite broadcast, the bit rate to the decoder in normal play may be around 40 Mbps and packets may be in irregular positions with gaps in between (partial transport stream). If the stream is compressed with the trick-play factor, the bit rate may be around 120 Mbps for a 3× trick-play speed. The necessary sustained bandwidth of a harddisk drive may also be increased with the trick-play factor.

So it would be appropriate to keep sending the correct amount of frames, but here a problem may occur when using a video coding technique like MPEG that exploits the temporal redundancy of video to achieve high compression ratios. Frames can no longer be decoded independently.

A structure of a plurality of groups of pictures (GOPs) is shown in FIG. 2.

Particularly, FIG. 2 shows a stream 200 comprising several MPEG2 GOP structures with a sequence of I-frames 201 and P-frames 202. The GOP size is denoted with reference numeral 203. The GOP size 203 is set to 12 frames, and only I-frames 201 and P-frames 202 are shown here.

In MPEG, a GOP structure may be used in which only the first frame is coded independently of other frames. This is the so-called intra-coded or I-frame 201. The predictive frames or P-frames 202 are coded with a unidirectional prediction, meaning that they only rely on the previous I-frame 201 or P-frame 202 as indicated by arrows 204 in FIG. 2.

Such a GOP structure has typically a size of 12 or 16 frames 201, 202. It is assumed that a trick-play speed of 2× forward is desired. So, for instance, every second frame should be skipped. This is not possible in the compressed domain due to the dependence on the reconstructed previous frame during decoding. So just dropping some compressed frames and fixing the timing information is no option.

The alternative is to decode the entire stream first, then skip every second frame and finally encode the remaining frames again. This may lead to an unacceptable complexity of the trick-play circuitry or software. So in the best case, some frames can be skipped from the GOP, on which no other frames rely. For the example of a trick-play speed of 2× with a GOP size of 12 frames, only the last 6 P-frames can be skipped. In this case, the displayed images tend to be of a “jumpy” nature, where a short normal speed period is obtained, followed by a sudden jump in time. Especially at higher trick-play speeds this may be unpleasant and does not give the viewer the look and feel of usual trick-play.

Another structure 300 of a plurality of groups of pictures (GOP) is shown in FIG. 3.

Particularly, FIG. 3 shows the MPEG2 GOP structure with a sequence of I-frames 201, P-frames 202 and B-frames 301. The GOP size is again denoted with reference numeral 203.

It is possible to use a GOP structure containing also bi-directionally predictive frames or B-frames 301 as shown in FIG. 3. A GOP size 203 of 12 frames is chosen for the example. The B-frames 301 are coded with a bi-directional prediction, meaning that they rely on a previous and a next I- or P-frame 201, 202 as indicated for some B-frames 301 by curved arrows 204. The transmission order of the compressed frames may be not the same as the order in which they are displayed.

To decode a B-frame 301, both reference frames before and after the B-frame 301 (in display order) are needed. To minimize the buffer demand in a decoder, the compressed frames may be reordered. So in transmission, the reference frames may come first. The reordered stream, as it is transmitted, is also shown in FIG. 3, lower part. The reordering is indicated by straight arrows 302. A stream containing B-frames 301 can give a nice looking trick-play picture if all the B-frames 301 are skipped. For the present example, this leads to a trick-play speed of 3× forward.

Whatever structure the stream has, the solutions described until now, may give an acceptable form of trick-play for a fast-forward mode. For reverse, the frames would have to be reordered in time, but due to the fact that MPEG uses the temporal correlation between successive frames to achieve a high compression ratio, the order in which the frames have to be decoded is fixed. Therefore, a GOP first has to be decoded in forward direction. The order of the GOPs sent to the decoder can be reversed, and GOPs can be skipped for higher reverse trick-play speeds. Reducing the GOPs by skipping P-frames or B-frames as described above is also possible in this case. Anyway, it may result in a displayed sequence of forward play and backward jumps. Therefore, the trick-play frames have to be selected from the decoded GOP and reversed in order, after which the frames are re-encoded. Then the previous GOP is fetched and processed and so on. Although possible, the complexity of such procedure may be high.

A conclusion from the foregoing considerations is that using only the I-frames in the trick-play generation may be a proper solution, because these frames can be decoded independently. As a result, the trick-play generation may be easier especially for reverse. Additionally, the use of only I-frames already allows for trick-play speeds down to 3× or 4×. For really low trick-play speeds, the more complex techniques mentioned above may be implemented.

In the following, some aspects related to a CPI (“characteristic point information”) file will be described.

Finding I-frames in a stream usually requires parsing the stream, to find the frame headers. Locating the positions where the I-frame starts can be done while the recording is being made, or off-line after the recording is completed, or semi on-line, in fact being off-line but with a small delay with respect to the moment of recording. The I-frame end can be found by detecting the start of the next P-frame or B-frame. The meta-data derived this way can be stored in a separate but coupled file which may be denoted as characteristic point information file or CPI file. This file may contain pointers to the start and eventually end of each I-frame in the transport stream file. Each individual recording may have its own CPI file.

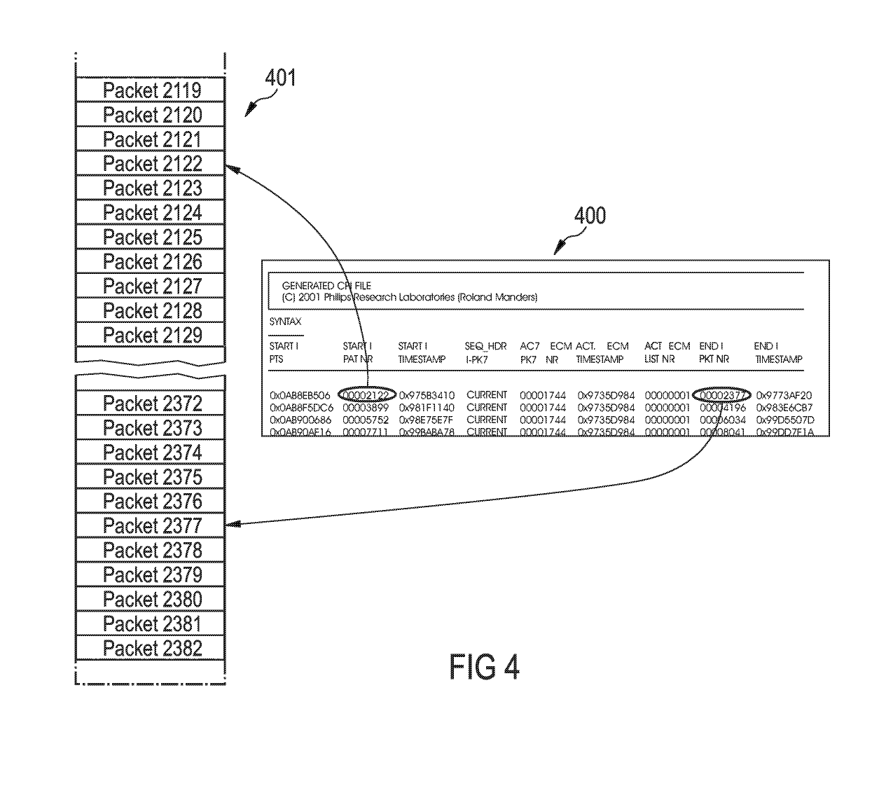

The structure of a characteristic point information file 400 is visualized in FIG. 4.

Apart from the CPI file 400, stored information 401 is shown. The CPI file 400 may also contain some other data that are not discussed here.

With the data from the CPI file 400 it is possible to jump to the start of any I-frame 201 in the stream. If the CPI file 400 also contains the end of the I-frames 201, the amount of data to read from the transport stream file is exactly known to get a complete I-frame 201. If for some reason the I-frame end is not known, the entire GOP or at least a large part of the GOP data is to be read to be sure that the entire I-frame 201 is read. The end of the GOP is given by the start of the next I-frame 201. It is known from measurements that the amount of I-frame data can be 40% or more of the total GOP data.

With the retrieved I-frames 201, a new trick-play stream that complies with the MPEG-2 transport stream format can be constructed. All that is needed is that the frames for the trick-play stream are re-multiplexed correctly, in such a manner that no buffer problems for the MPEG decoder will occur. Although this seems to be a straightforward solution, it is not a trivial solution as will become clear in the following.

Next, some aspects related to as to how to construct a trick-play stream will be described.

With the help of the CPI file, describing at what packet position an I-frame 201 starts, as well as where the I-frame 201 ends, access is provided to all I-frames 201 from the original stream. But just concatenating adequately chosen I-frames 201 into one big stream of only I-frames 201 does not result in a valid MPEG stream, as will become clear from the following.

The first point to investigate is the bit rate of the trick-play stream. For example, the original stream has an average video bit rate of 4 Mbps and a GOP size 203 of 12 frames. The bit rate may be extracted from a measurement on a real broadcast stream. It is assumed that the trick-play stream consists of I-frames 201 only that are each displayed one frame time, leading to a refresh rate of the trick-play stream equal to normal play. It is recalled that the amount of I-frame 201 data could be 40% of the GOP data. This number originates from a measurement, where the average has been around 25%. So on average 25% of the data have to be compressed into 1/12 of the time, leading to a 3 times higher bit rate. Thus the average trick-play bit rate would be 12 Mbps with peaks up to around 20 Mbps. This simple example is intended to provide some feeling for the bit rate effect and its origin.

In fact, the sizes of the I-frames 201 are known or are derivable from the measurement. Therefore, the bit rate for an I-frame 201 only trick-play stream as a function of time can easily be calculated accurately. The trick-play bit rate may be 2 to 3 times higher than the normal play bit rate and sometimes it may be higher than allowed by the MPEG2 standard. Taking into account that this is an example with a moderate bit rate stream and that streams with higher bit rates will surely be encountered, it is clear that some form of bit rate reduction has to be applied. For instance, the trick-play bit rate may be comparable to the normal play bit rate. This is especially important if the streams are sent to a decoder via a digital interface. Additional demand on bandwidth from the interface due to trick-play should be avoided. A first option is to reduce the size of the I-frames 201. However, this may add complexity and limitations in relation to trick-play for encrypted streams.

An option, which may be appropriate for particular applications, is to reduce the trick-play picture refresh rate by displaying each I-frame 201 several times. The bit rate will be reduced accordingly. This may be achieved by adding so-called empty P-frames 202 between the I-frames 201. Such an empty P-frame 202 is not really empty but may contain data instructing the decoder to repeat the previous frame. This has a limited bit cost, which can in many cases be neglected compared to an I-frame 201. From experiments it is known that trick-play GOP structures like IPP or IPPP may be acceptable for the trick-play picture quality and even advantageous at high trick-play speeds. The resulting trick-play bit rate is of the same order as the normal play bit rate. It is also mentioned that these structures may reduce the required sustained bandwidth from the storage device.

In the following, some aspects related to timing issues and stream construction will be described.

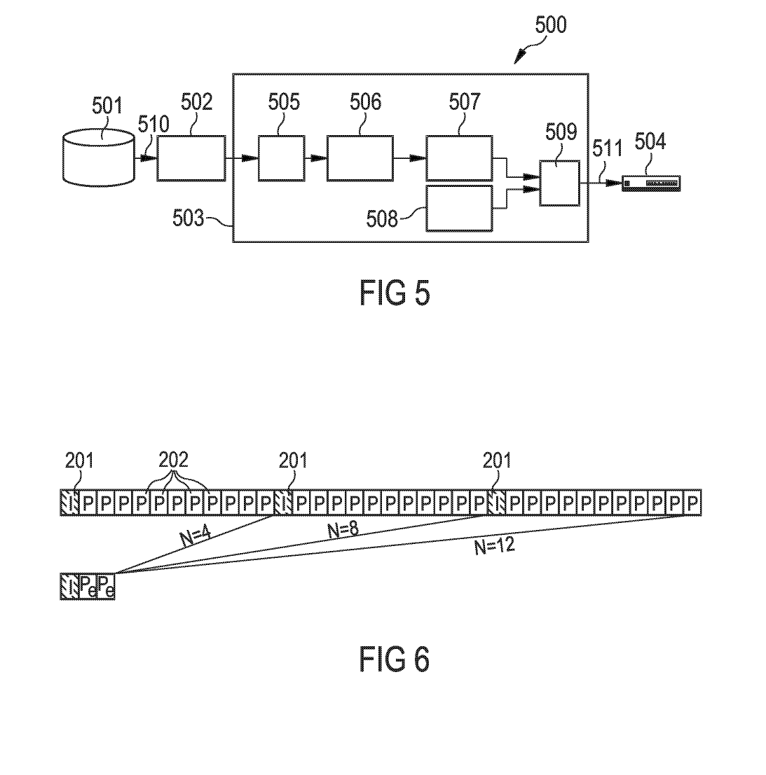

A trick-play system 500 is schematically depicted in FIG. 5.

The trick-play system 500 comprises a recording unit 501, an I-frame selection unit 502, a trick-play generation block 503 and an MPEG2 decoder 504. The trick-play generation block 503 includes a parsing unit 505, an adding unit 506, a packetizer unit 507, a table memory unit 508 and a multiplexer 509.

The recording unit 501 provides the I-frame selection unit 502 with plaintext MPEG2 data 510. The multiplexer 509 provides the MPEG2 decoder 504 with an MPEG2 DVB compliant transport stream 511.

The I-frame selector 502 reads specific I-frames 201 from the storage device 501. Which I-frames 201 are chosen depends on the trick-play speed as will be described below. The retrieved I-frames 201 are used to construct an MPEG-2/DVB compliant trick-play stream that is then sent to the MPEG-2 decoder 504 for decoding and rendering.

The position of the I-frame packets in the trick-play stream cannot be coupled to the relative timing of the original transport stream. In trick-play, the time axis may be compressed with the speed factor and additionally inversed for reverse trick-play. Therefore, the time stamps of the original time stamped transport stream may not be suitable for trick-play generation.

Moreover, the original PCR time base may be disturbing for trick-play. First of all it is not guaranteed that a PCR will be available within the selected I-frame 201. But even more important is that the frequency of the PCR time base would be changed. According to the MPEG2 specification, this frequency should be within 30 ppm from 27 MHz. The original PCR time base fulfils this requirement, but if used for trick-play it would be multiplied by the trick-play speed factor. For reverse trick-play this even leads to a time base running in the wrong direction. Therefore, the old PCR time base has to be removed and a new one added to the trick-play stream.

Finally, I-frames 201 normally contain two time stamps that tell the decoder 504 when to start decoding the frame (decoding time stamp, DTS) and when to start presenting, for instance displaying, it (presentation time stamp, PTS). Decoding and presentation may be started when DTS respectively PTS are equal to the PCR time base, which is reconstructed in the decoder 504 by means of the PCRs in the stream. The distance between, e.g., the PTS values of 2 I-frames 201 corresponds to their nominal distance in display time. In trick-play this time distance is compressed with the speed factor. Since a new PCR time base is used in trick-play, and because the distance for DTS and PTS is no longer correct, the original DTS and PTS of the I-frame 201 have to be replaced.

To solve above-mentioned complications, the I-frame 201 may first be parsed into an elementary stream in the parsing unit 505. Then the empty P-frames 202 are added on elementary stream level. The obtained trick-play, GOP is mapped into one PES packet and packetized to transport stream packets. Then corrected tables like PAT, PMT, etc. are added. At this stage, a new PCR time base together with DTS and PTS are included. The transport stream packets are pre-pended with a 4 bytes time stamp that is coupled to the PCR time base such that the trick-play stream can be handled by the same output circuitry as used for normal play.

In the following, some aspects related to trick-play speeds will be described.

In this context, firstly, fixed trick-play speeds will be discussed.

As mentioned before, a trick-play GOP structure like IPP may be used in which the I-frame 201 is followed by two empty P-frames 202. It is assumed that the original GOP has a GOP size 203 of 12 frames and that all the original I-frames 201 are used for trick-play. This means that the I-frames 201 in the normal play stream have a distance of 12 frames and the same I-frames 201 in the trick-play stream a distance of 3 frames. This leads to a trick-play speed of 12/3=4×. If the original GOP size 203 in frames is denoted by G, the trick-play GOP size in frames by T and the trick-play speed factor by N_{b}, the trick-play speed in general is given by:

N_{b}=G/T (1)

N_{b} will also be denoted as the basic speed. Higher speeds can be realized by skipping I-frames 201 from the original stream. If every second I-frame 201 is taken, the trick-play speed is doubled, if every third I-frame 201 is taken, the trick-play speed is tripled and so on. In other words, the distance between the used I-frames 201 of the original stream is 2, 3 and so on. This distance may be always an integer number. If the distance between the I-frames 201 used for trick-play generation is denoted by D (D=1 meaning that every I-frame 201 is used), then the general trick-play speed factor N is given by:

N=D*G/T (2)

This means that all integer multiples of the basic speed can be realized, leading to an acceptable set of speeds. It should be noticed that D is negative for reverse trick-play and that D=0 results in a still picture. Data can only be read in a forward direction. Therefore, in reverse trick-play, data is read forward and jumps are made backwards to retrieve the preceding I-frame 201 given by D. It should also be noticed that a larger trick-play GOP size T results in a lower basic speed. For instance, IPPP leads to a finer grained set of speeds than IPP.

In the following, referring to FIG. 6, time compression in trick-play will be explained.

FIG. 6 shows the situation for T=3 (IPP) and G=12. For D=2, an original display time of 24 frames is compressed into a trick-play display time of 3 frames resulting in N=8. In the given example, the basic speed is an integer but this is not necessarily the case. For G=16 and T=3, the basic speed is 16/3=5⅓ which does not result in a set of integer trick-play speeds. Therefore, the IPPP structure (T=4) is better suited for a GOP size of 16 resulting in a basic speed of 4×. If a single trick-play structure is desired that fits to the most common GOP sizes of 12 and 16, IPPP may be chosen.

Secondly, arbitrary trick-play speeds will be discussed.

In some cases, the set of trick-play speeds resulting from the method described above is satisfying, in some cases not. In the case of G=16 and T=3 one probably still would prefer integer trick-play speed factors. Even in the case of G=12 and T=4 it might be preferred to have a speed not available in the set like for instance 7×. Now, the trick-play speed formula will be inverted and the distance D will be calculated which is given by:

D=N*T/G (3)

Using the above example with G=12, T=4 and N=7 results in D=2⅓. Instead of skipping a fixed number of I-frames 201, an adaptive skipping algorithm might be used that chooses the next I-frame 201 based on the fact what I-frame 201 best matches the required speed. To choose the best matching I-frame 201, the next ideal point Ip with the distance D may be calculated and one of the I-frames 201 may be chosen closest to this ideal point to construct a trick-play GOP. In the following step, again the next ideal point may be calculated by increasing the last ideal point by D.

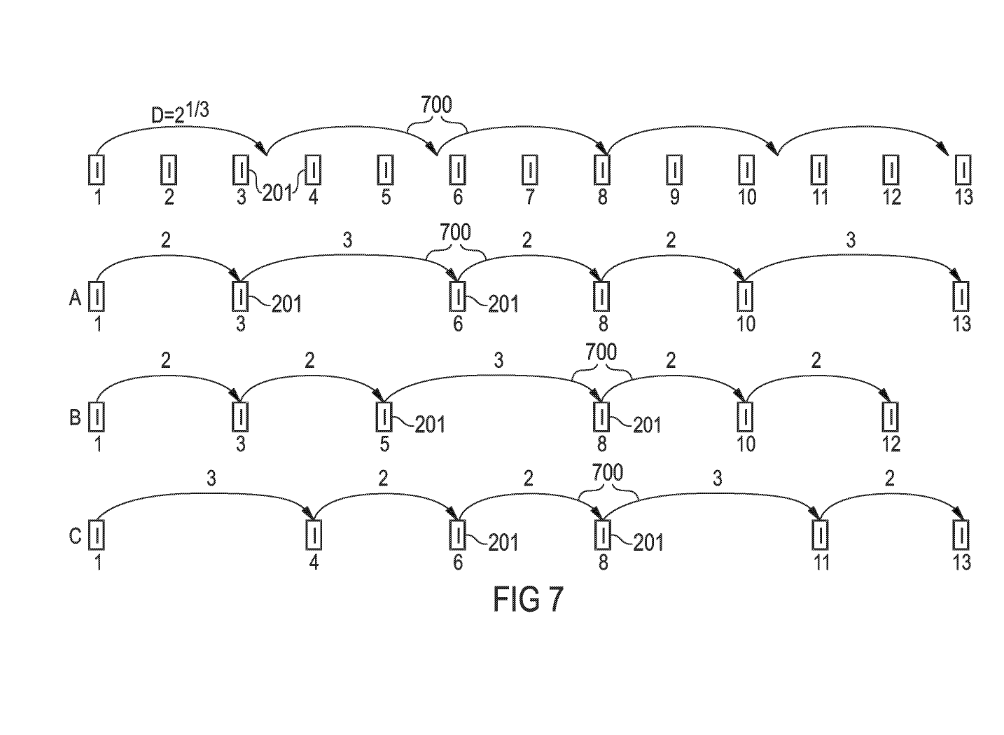

As visualized in FIG. 7 illustrating trick-play with fractional distances, there are particularly three possibilities to choose the I-frame 201:

A. The I-frame closest to the ideal point; I=round(Ip)

B. The last I-frame before the ideal point; I=int(Ip)

C. The first I-frame after the ideal point; I=int(Ip)+1

As can clearly be seen, the actual distance is varying between int(D) and int(D)+1, the ratio between the occurrences of the two being dependent on the fraction of D, such that the average distance is equal to D. This means that the average trick-play speed is equal to N, but that the actually used frame has a small jitter with respect to the ideal frame. Several experiments have been performed with this, and although the trick-play speed may vary locally, this is not visually disturbing. Usually, it is not even noticeable especially at somewhat higher trick-play speeds. It is also clear from FIG. 7 that it makes no essential difference whether to choose method A, B or C.

With this method, trick-play speed N does not need to be an integer but can be any number above the basic speed N_{b}. Also speeds below this minimum can be chosen, but then the picture refresh rate may be lowered locally because the effective trick-play GOP size T is doubled or at still lower speeds even tripled or more. This is due to a repetition of the trick-play GOPs, as the algorithm will choose the same I-frame 201 more than once.

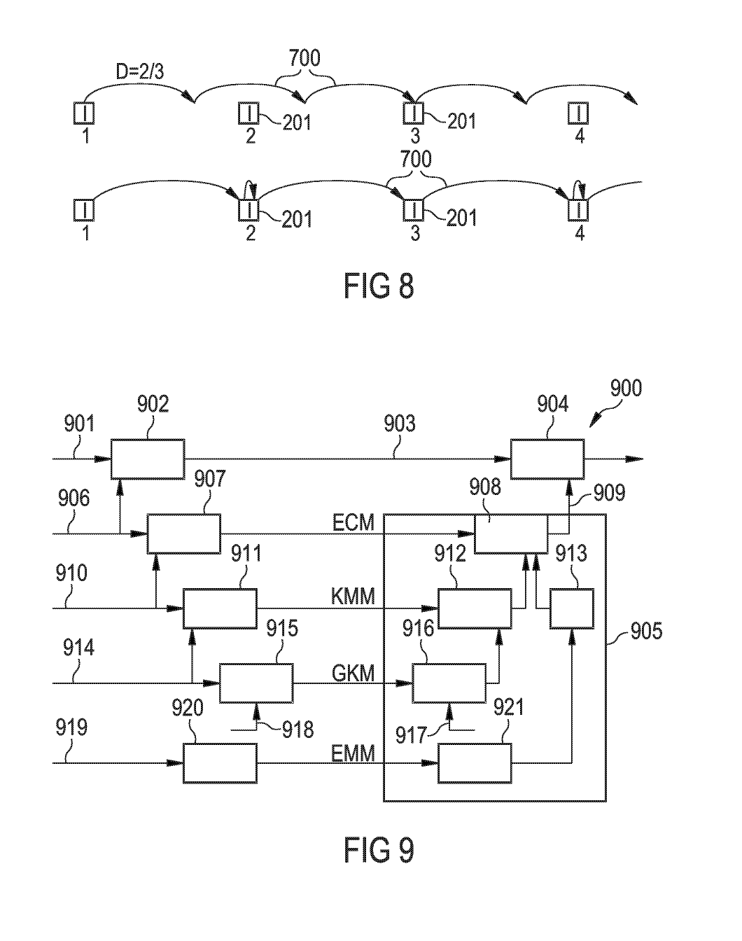

FIG. 8 shows an example for D=⅔ which is equivalent to N=⅔ N_{b}. Here, the round function is used to select the I-frames 201 and as can be seen frames 2 and 4 are selected twice.

Anyway, the described method will allow for a continuously variable trick-play speed. For reverse trick-play a negative value is chosen for N. For the example of FIG. 7 this simply means that the arrows 700 are pointing in the other direction. The method described will also include the sets of fixed trick-play speeds mentioned earlier and they will have the same quality, especially if the round function is used. Therefore, it might be appropriate that the flexible method described in this section should always be implemented whatever the choice of the speeds will be.

In the following, some aspects related to the refresh rate of the trick-play picture will be discussed.

The term “refresh rate” particularly denotes the frequency with which new pictures are displayed. Although not speed dependent, it will be briefly discussed here because it can influence the choice of T. If the refresh rate of the original picture is denoted by R (25 Hz or 30 Hz), the refresh rate of the trick-play picture (Rₜ) is given by:

Rₜ=R/T (4)

With a trick-play GOP structure of IPP (T=3) or IPPP (T=4), the refresh rate Rₜ is 8⅓ Hz respectively 6¼ Hz for Europe and 10 Hz respectively 7½ Hz for the USA. Although the judgement of trick-play picture quality is a somewhat subjective matter, there are clear hints from experiments that these refresh rates are acceptable for low speeds and even advantageous at higher speeds.

In the following, some aspects related to encrypted stream environments will be described.

In the following, some information about encrypted transport streams is presented as a basis for the description of trick-play on encrypted streams. It is focussed on the Conditional Access System used for broadcast.

FIG. 9 illustrates a conditional access system 900 which will be described in the following.

In the conditional access system 900, content 901 may be provided to a content encryption unit 902. After having encrypted the content 901, the content encryption unit 902 supplies a content decryption unit 904 with encrypted content 903.

A Control Word 906 may be supplied to the content encryption unit 902 and to a ECM generation unit 907. The ECM generation unit 907 generates an ECM and provides the same to an ECM decoding unit 908 of a smartcard 905. The ECM decoding unit 908 generates from the ECM a Control Word that is decryption information that is needed and provided to the content encryption unit 904 to decrypt the encrypted content 903.

Furthermore, an authorization key 910 is provided to the ECM generation unit 907 and to a KMM generation unit 911, wherein the latter generates a KMM and provides the same to a KMM decoding unit 912 of the smartcard 905. The KMM decoding unit 912 provides an output signal to the ECM decoding unit 908.

Moreover, a group key 914 may be provided to the KMM generation unit 911 and to a GKM generation unit 915 which may further be provided with a user key 918. The GKM generation unit 915 generates a GKM signal GKM and provides the same to a GKM decoding unit 916 of the smartcard 905, wherein the GKM decoding unit 916 gets as a further input a user key 917.

Beyond this, entitlements 919 may be provided to an EMM generation unit 920 that generates an EMM signal and provides the same to an EMM decoding unit 921. The EMM decoding unit 921 located in the smartcard 905 is coupled with an entitlement list unit 913 which provides the ECM decoding unit 908 with corresponding control information.

ECM denotes Entitlement Control Messages, KMM denotes Key Management Messages, GKM denotes Group Key Messages, and EMM denotes Entitlement Management Messages.

In many cases, content providers and service providers want to control access to certain content items through a conditional access (CA) system.

To achieve this, the broadcasted content 901 is encrypted under the control of the CA system 900. In the receiver, content is decrypted before decoding and rendering if access is granted by the CA system 900.

The CA system 900 uses a layered hierarchy (see FIG. 9). The CA system 900 transfers the content decryption key (Control Word CW 906, 909) from server to client in the form of an encrypted message, called ECM (Entitlement Control Message). ECMs are encrypted using an authorization key (AK) 910. For security reasons, the CA server 900 may renew the authorization key 910 by issuing a KMM (Key Management Message). A KMM is in fact a special type of EMM (Entitlement Management Message), but for clarity the term KMM may be used. KMMs are also encrypted using a key that for instance can be a group key (GK) 914, which is renewed by sending a GKM (Group Key Message) that is again a special type of EMM. GKMs are then encrypted with the user key (UK) 917, 918, which is a fixed unique key embedded in the smartcard 905 and known by the CA system 900 of the provider only. Authorization keys and group keys are stored in the smartcard 905 of the receiver.

Entitlements 919 (for instance viewing rights) are sent to individual customers in the form of an EMM (Entitlement Management Message) and stored locally in a secure device (smartcard 905). Entitlements 919 are coupled to a specific program. An entitlements list 913 gives access to a group of programs depending on the type of subscription. ECMs are only processed into keys (Control Words) by the smartcard 905 if an entitlement 919 is available for the specific program. Entitlement EMMs are subject to an identical layered structure as the KMMs (not depicted in FIG. 9).

In an MPEG2 system, encrypted content, ECMs and EMMs (including the KMM and GKM types) are all multiplexed into a single MPEG2 transport stream.

The description above is a generalized view of the CA system 900. In digital video broadcasting, only the encryption algorithm, the odd/even Control Word structure, the global structure of ECMs and EMMs and their referencing are defined. The detailed structure of the CA system 900 and the way the payloads of ECMs and EMMs are encoded and used are provider specific. Also the smartcard is provider specific. However, from experience it is known that many providers follow essentially the structure of the generalized view of FIG. 9.

In the following, DVB Encryption/Decryption topics will be discussed.

The applied encryption and decryption algorithm is defined by the DVB standardisation organisation. In principle two encryption possibilities are defined namely PES level encryption and TS level encryption. However, in real life mainly the TS level encryption method is used. Encryption and decryption of the transport stream packets is done packet based. This means that the encryption and decryption algorithm is restarted every time a new transport stream packet is received. Therefore, packets can be encrypted or decrypted individually. In the transport stream, encrypted and plaintext packets are mixed because some stream parts are encrypted (e.g. audio/video) and others are not (e.g. tables). Even within one stream part (e.g. video) encrypted and plaintext packets may be mixed.

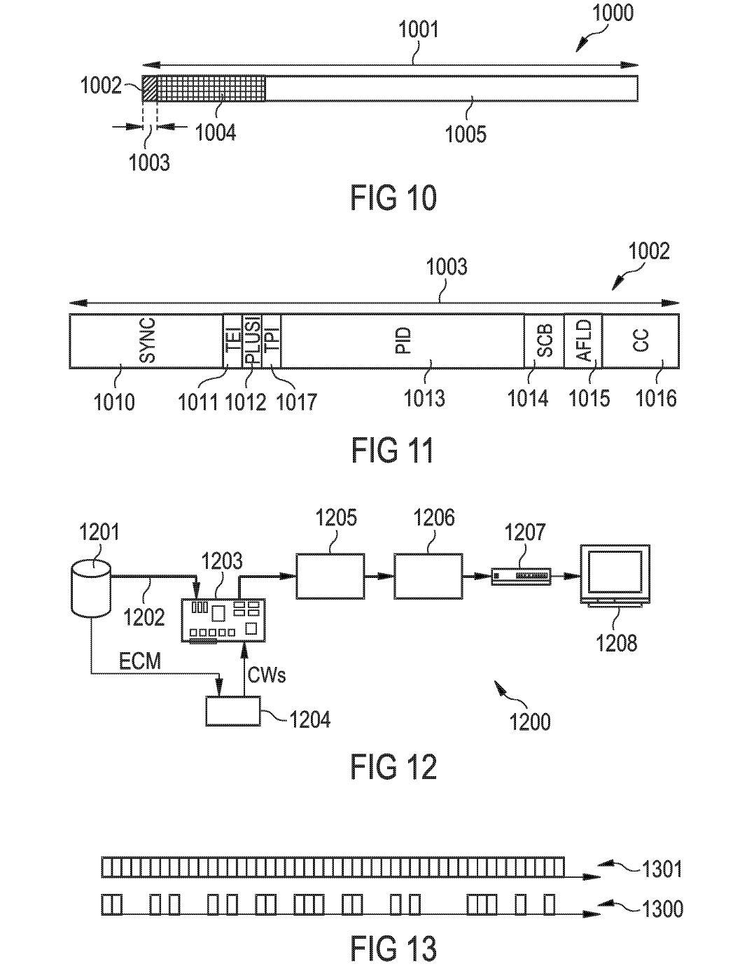

In the following, referring to FIG. 10, a DVB encrypted transport stream packet 1000 will be described.

The stream packet 1000 has a length 1001 of 188 Bytes and comprises three portions. A packet header 1002 has a size 1003 of 4 Bytes. Subsequent to the packet header 1002, an adaptation field 1004 may be included in the stream packet 1000. After that, a DVB encrypted packet payload 1005 may be sent.

FIG. 11 illustrates a detailed structure of the transport stream packet header 1002 of FIG. 10.

The transport stream packet header 1002 comprises a synchronization unit (SYNC) 1010, a transport error indicator (TEI) 1011 which may indicate transport errors in a packet, a payload unit start indicator (PLUSI) 1012 which may particularly indicate a possible start of a PES packet in the subsequent payload 1005, a transport priority unit (TPI) 1017 indicating priority of the transport, a packet identifier (PID) 1013 used for determining the assignment of the package, a transport scrambling control (SCB) 1014 is used to select the CW that is needed for decrypting the transport stream packet, an adaptation field control (AFLD) 1015, and a continuity counter (CC) 1016. Thus, FIG. 10 and FIG. 11 show the MPEG2 transport stream packet 1000 that has been encrypted and which comprises different parts:
Packet header 1002 is in plaintext. It serves to obtain important information such as a packet identifier (PID) number, presence of an adaptation field, scrambling control bits, etc.
Adaptation field 1004 is also in plaintext. It can contain important timing information such as the PCR.
DVB Encrypted Packet Payload 1005 contains the actual program content that may have been encrypted using the DVB algorithm.

In order to select the correct CW that is needed to decrypt the broadcasted program it is necessary to parse the transport stream packet header. A schematic overview of this header is given in FIG. 11. An important field for the decryption of the broadcasted program is the scrambling control bits (SCB) field 1014. This SCB field 1014 indicates which CW the decrypter must use to decrypt the broadcasted program. Moreover, it indicates whether the payload of the packet is encrypted or in plaintext. For every new transport stream packet, this SCB 1014 must be parsed since it changes over time and can change from packet to packet.

In the following, some aspects related to trick-play on fully encrypted streams will be described.

The first reason why this is an interesting topic is that trick-play on plaintext and fully encrypted streams are the two extremes of a range of possibilities. Another reason is that there exist applications in which it may be necessary to record fully encrypted streams. Thus, it would be useful to have a technique at hand to perform trick-play on a fully encrypted stream. A basic principle is to read a large enough block of data from the storage device, decrypt it, select an I-frame in the block and construct a trick-play stream with it.

Such a system 1200 is depicted in FIG. 12

FIG. 12 shows the basic principle of trick-play on a fully encrypted stream. For this purpose, data stored in a harddisk 1201 are provided as a transport stream 1202 to a decrypter 1203. Further, the harddisk 1201 provides a smartcard 1204 with an ECM, wherein the smartcard 1204 generates Control Words from this ECM and sends the same to the decrypter 1203.

Using the Control Words, the decrypter 1203 decrypts the encrypted transport stream 1202 and sends the decrypted data to an I-frame detector and filter 1205. From there, the data are provided to an insert empty P frame unit 1206 which conveys the data to a set top box 1207. From there, data are provided to a television 1208.

In the following, some aspects will be mentioned with respect to the question what a recording contains.

Making a recording of a single channel, the recording must contain all the data required to playback the recording of the channel at a later stage. One can resort to just record everything on a certain transponder, but this way one would record far more than one needs to playback the program intended to record. This means that both bandwidth and storage space would be wasted. So instead of this, only the packets really needed should be recorded. For each program this means one must record all the MPEG2 mandatory packets like PAT (program association table), CAT (conditional access table), and obviously for each program the video and audio packets as well as the PMT (program map table) that describes which packets belong to a program. Furthermore, the CAT/PMT may describe CA packets (ECMs) needed for decryption of the stream. Unless the recording is made in plaintext after decryption, those ECM packets have to be recorded as well.

If the recording made does not consist of all packets from the full multiplex, the recording becomes a so-called partial transport stream 1300 (see FIG. 13). Further, FIG. 13 illustrates a full transport stream 1301. The DVB standard requires that if a partial transport stream 1300 is played, all normal DVB mandatory tables like NIT (network information table), BAT (bouquet association table) etc. are removed. Instead of these tables, the partial stream should have SIT (selection information table) and DIT (discontinuity information table) tables inserted.

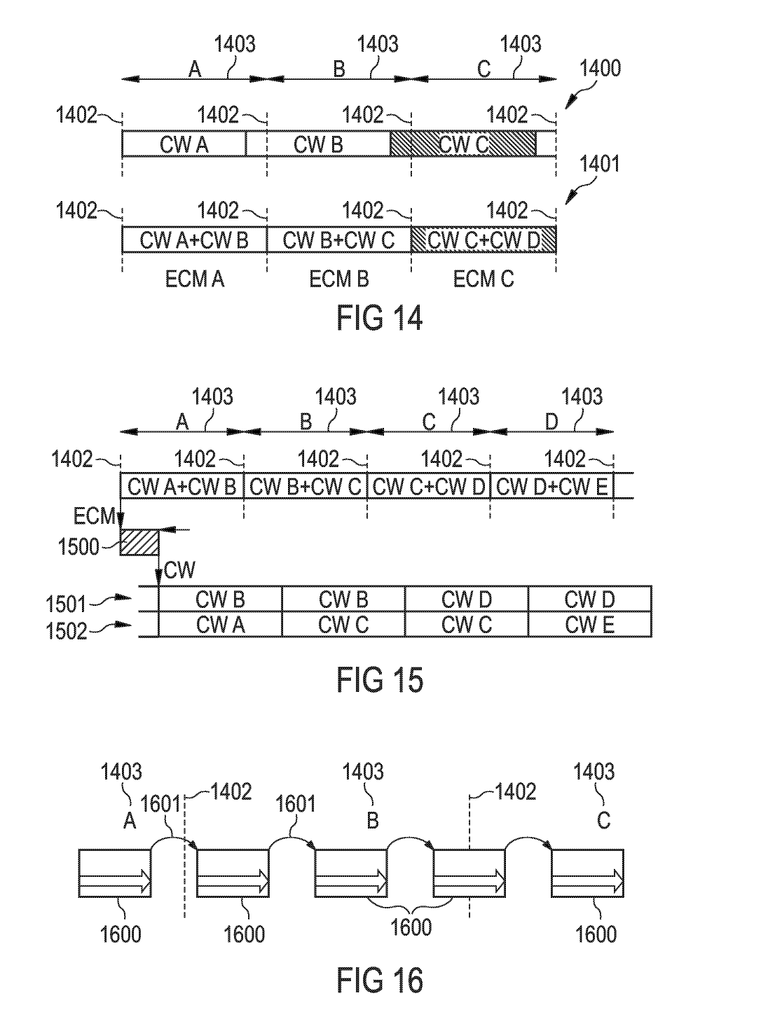

In the following, referring to FIG. 14 to FIG. 32, systems will be described which are capable of processing an encrypted data stream according to exemplary embodiments of the invention.

It is emphasized that the systems described in the following can be implemented in the frame of and in combination with any of the systems described referring to FIG. 1 to FIG. 13.

In the following, some aspects related to dealing with ECMs (Entitlement Control Messages) will be described.

Jumping to the next block during trick-play can mean jumping back in the stream. In the following, it will be explained that this may not be only the case for trick-play reverse but also for trick-play forward at moderate speeds. The situation for forward trick-play with forward jumps and for reverse trick-play with inherently backward jumps will be explained afterwards.

Specific problems may occur caused by the fact that data has to be decrypted. A conditional access system may be designed for transmission. In normal play, the transmitted stream may be reconstructed with original timings. But trick-play may have severe implications for the handling of cryptographic metadata due to changed timings. The data may be compressed in time due to trick-play, but the latency of the smartcard may remain constant.

To create a trick-play stream, the mentioned data blocks may go through a decrypter. This decrypter needs the Control Words used in the encryption process to decrypt the data blocks. These Control Words may also be encrypted and stored in ECMs. In a normal set-top-box (STB), these ECMs may be part of the program tuned to. A conditional access module may extract the ECMs, send them to a smartcard, and, if the card has rights or an authorization to decrypt these ECMs, may receive the decrypted Control Words from it. Control Words usually have a relatively short lifetime of, for instance, approximately 10 seconds. This lifetime may be indicated by the Scrambling Control Bit (SCB) in the transport stream packet headers. If it changes, the next Control Word has to be used. This SCB change or toggle is indicated in FIG. 14 by a vertical line and with a reference numeral 1402.

Referring to FIG. 14, particularly two different scenarios or stream types may be distinguished:

According to a stream type I shown in a lower row 1401 in FIG. 14, two Control Words (CWs) are provided per Entitlement Control Message (ECM).

According to a stream type II shown in an upper row 1400 in FIG. 14, only one Control Word (CW) is provided per Entitlement Control Message (ECM).

FIG. 14 illustrates the two data streams 1400, 1401 comprising subsequently arranged periods or segments A, B, C denoted with reference numeral 1403. In the scenario illustrated in the upper row 1400 of FIG. 14, essentially one Control Word per corresponding ECM is provided. In contrast to this, in the lower row 1401, each ECM comprises two Control Words, namely the Control Word relating to the current period or ECM, and additionally the Control Word of the subsequent period or ECM. Thus, there is some redundancy concerning the provision of the Control Words.

During the short lifespan, items of the decryption information may be transmitted several times, so that tuning to such a channel halfway through the lifespan of such a Control Word does not mean waiting for the next Control Word. The conditional access module may only send the first unique ECM it finds to the smartcard to reduce or minimize the traffic to the card, as it may have a fairly slow processor.

This shows that there may be a limitation of trick-play on encrypted streams. There may be an implicit upper speed limit, coming from the limited speed of the processing capability of the smartcard. In trick-play, the Control Word lifetime of 10 seconds may be compressed with the trick-play speed factor. It is also possible to say that the frequency of sending ECMs to the smartcard is multiplied with the speed factor. Sending an ECM to a smartcard and receiving the decrypted Control Words may take approximately half a second. With a lifetime for each Control Word of 10 seconds, the maximum trick-play speed may be limited to 20 times. But to reach this 20 times, it may be required that the ECMs are sent or provided at the correct moment. In reverse, they have to be sent in some reverse order. This means that it may not be possible to just rely on their positions in the original stream. The way Control Words are packed into an ECM may be provider-specific and particularly different for stream type I and stream type II, as depicted in FIG. 14.

CW A denotes the CW that was used to encrypt period A, CW B denotes the CW that was used to encrypt period B, and so on. Horizontally, the transmission time axis is plotted. ECM A may be defined as being the ECM that is present during the major part of period A. It can be seen that, in that case, ECM A holds the CW for the current period A and for stream type I additionally for the next period B. In general, an ECM may hold at least the CW for the current period and might hold the CW for the next period. Due to zapping, this may probably be true for all or many providers.

In the following, some aspects related to forward trick-play will be discussed.

Next, it will be described how skipping some of the I-frames may generate a fairly high-speed fast-forward. In trick-play, the data and therefore the SCB period may be compressed by an amount equal to the speed factor. It may be assumed that nothing special is done, and it is left to the STB to use the original ECMs embedded in the stream. For stream type I, this may be no problem as long as the compressed SCB period is longer than the latency of the smartcard because, for instance, ECM B also holds the CW for period C (see FIG. 14). Therefore, the whole of period B may be available for the decryption of CW C that should be available at the start of period C for decryption of the video data. This may result in a maximum trick-play speed equal to the ratio of the SCB period and the smartcard latency, for instance 20×. However, CW C may be not present in ECM B for stream type II, and as a result this method may fail for stream type II.

Before going on, more information will be provided about a decrypter and how it may handle the CWs. The decrypter may contain two registers, one for the “odd” and one for the “even” CW. “Odd” and “even” does not have to mean that the values of the CWs themselves are odd or even. The terms are particularly used to distinguish between two subsequent CWs in the stream. Which CW has to be used for the decryption of a packet is indicated by the SCB in the packet header. So the CWs used to encrypt the stream are alternating between odd and even. In FIG. 14 this means that, for instance, CW A and CW C are odd, whereas CW B and CW D are even. After the decryption by the smartcard, CWs may be written to the corresponding registers in the decrypter overwriting previous values, as indicated in FIG. 15.

FIG. 15 illustrates the two registers 1501, 1502 containing even CWs (register 1501) and containing odd CWs (register 1502). Further, smartcard latency 1500, that is a time needed by the smartcard to retrieve or decrypt a CW from an ECM, is illustrated in FIG. 15.

In the case of stream type I, each ECM holds two CWs and as a result both registers 1501, 1502 may be overwritten after the decryption of the ECM. One of the registers 1501, 1502 is active and the other is inactive. Which one is active depends on the SCB. In the example, the SCB will indicate during period B that the even register 1501 is the active one. The active register may only be overwritten with a CW identical to the one it already holds because it is still needed for decryption of the remainder of that particular period. Therefore, only the inactive register may be overwritten with a new value.

Taking a closer look at period B in trick-play. Assuming that an ECM is sent to the smartcard at the start of this period so at the moment the SCB toggle 1402 is crossed. The question is what ECM could then be sent to the smart card?

This ECM should hold CW C to ensure a timely decryption by the smartcard for usage at the start of period C.

It may also hold CW B without disturbing the correct availability of CWs in the decrypter.

Looking again at FIG. 14, it can be seen that for stream type I this means sending ECM B and for stream type II ECM C at the start of period B. In general, the current ECM can be sent in case it holds two CWs, and one period in advance if it holds only one CW. Sending an ECM one period in advance may be contradictory though to the embedded ECMs, so the latter have to be removed from the stream in that case. For a more generalized approach it may be preferred that the original ECMs are always removed from the stream by the trick-play generation circuitry or software. An exemplary way to read data blocks, to jump forward in the stream and to send ECMs is indicated in FIG. 16.

FIG. 16 shows ECM handling in a fast forward mode.

In a plurality of subsequent periods 1403 separated by SCB toggles 1402, a plurality of data blocks 1600 are reproduced, wherein a switching 1601 occurs between different data blocks.

For stream type I, an ECM B is sent at a border between periods A and B. For stream type II, an ECM C is sent at a border between period A and period B. Furthermore, according to stream type I, an ECM C is sent at a border between period B and period C. For a stream type II, an ECM D is sent at a border between period B and period C.

For ECMs to be available for trick-play at the correct moment, the ECMs may be stored in a separate file. In this file it may also be indicated to which period an ECM belongs (which part of the recorded stream). The packets in the MPEG stream file may be numbered. The number of the first packet of a period (SCB toggle 1402) may be stored alongside with the ECM for this same period 1403. The ECM file may be generated during recording of the stream.

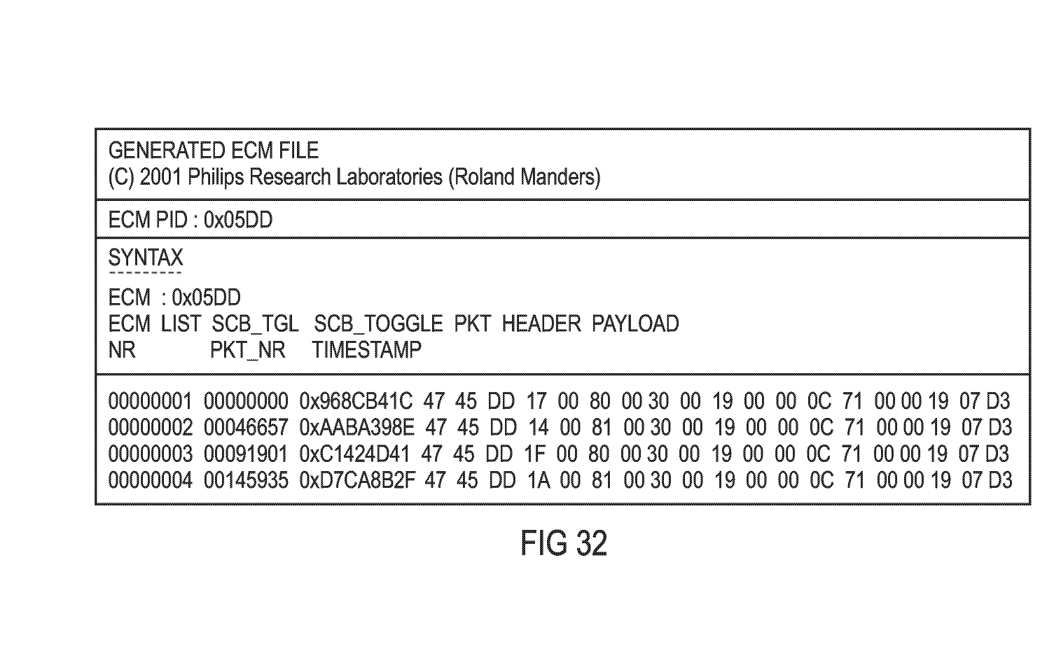

An example of an ECM file is shown in FIG. 32.

The ECM file is a file that may be created during the recording. In the stream, ECM packets may be located which may contain the Control Words needed to decrypt the video data. Every ECM may be used for a certain period, for instance 10 seconds, and may be transmitted (repeated) several times during this period (for instance 100 times). The ECM file may contain every first new ECM of such a period. The ECM data may be written into this file, and may be accompanied by some metadata. First of all, a serial number (counting up from 1) may be given. As a second field, the ECM file may contain the position of the SCB toggle. This may denote the first packet that can use this ECM to correctly decrypt its content. Then the position in time of this SCB toggle may follow as the third field. These three fields may be followed by the ECM packet data itself of which only the first bytes are depicted in FIG. 32. The differences between the ECMs are further down the payload and not visible here.

Using the SCB toggles stored in the ECM file, it may be easy to detect if such toggle is crossed even if this would be during a jump. To send the correct ECM, it may be required to know whether the ECMs contain one or two CWs. In principle, this is not known because it is provider-specific and secret. However, this can easily be determined experimentally by sending ECMs at various moments and observing the results on the display. An alternative method that is particularly suitable for implementation in the storage device itself is as follows. Send one single ECM to the smartcard at the moment of an SCB toggle, decrypt the stream and check for PES headers in the coming two periods. With one PES header per GOP, there are around twenty PES headers in each period. The position of a PES header may be easily detected because a PLUSI bit in the plaintext header of the packet may indicate its presence. If correct PES headers are only found during the first period (after the latency of the smartcard), the ECM contains one CW. If they are also found during the second period, it contains two CWs.

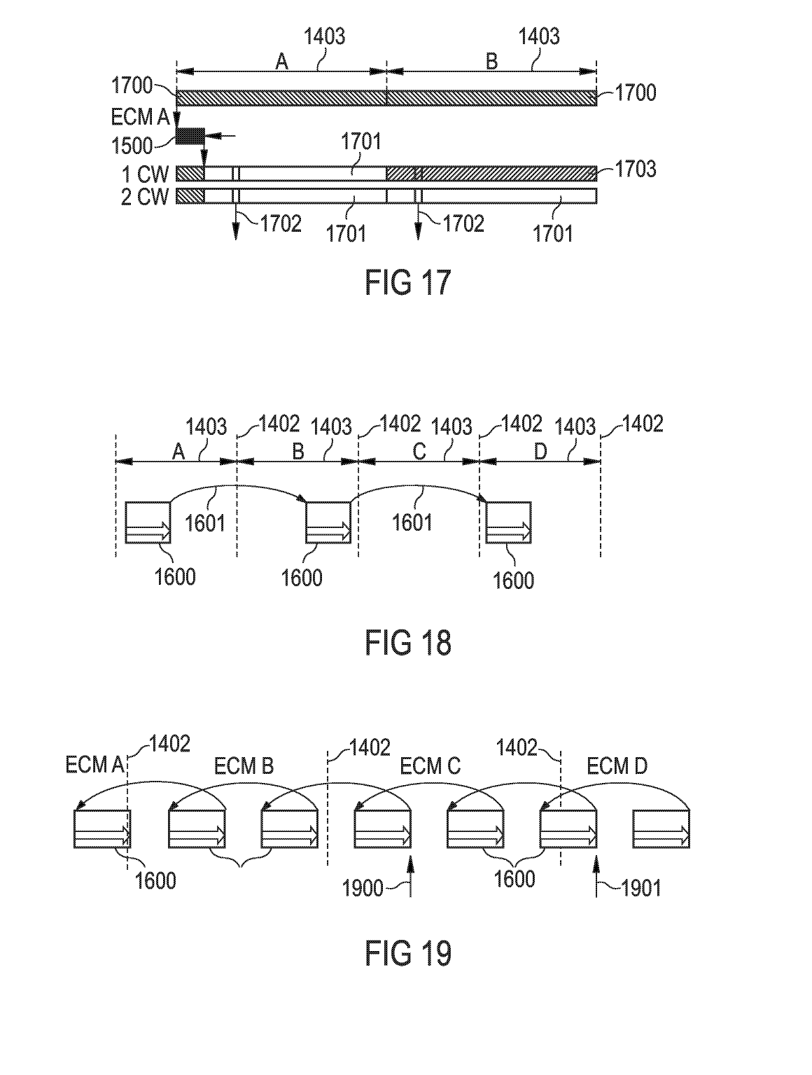

Such a situation is depicted in FIG. 17.

FIG. 17 illustrates a situation for one CW detection and for two CW detection. As can be seen, different periods 1403 of encrypted content 1700 are provided. With a smartcard latency 1500, an ECM A may be decrypted to generate corresponding CWs. By decrypting the encrypted content 1700, decrypted content 1701 may be generated. Further shown in FIG. 17 are PES headers 1702, namely a PES header A in period A (left) and a PES header B in period B (right).

The area 1703 of period B for one CW in FIG. 17 indicates that the data is decrypted with the wrong key and therefore scrambled. This checking could be done while recording, in which case it will take for instance 20 to 30 seconds. It could also be done off-line and, because only two packets indicated by the PLUSIs (one in each period) would have to be checked, it could be very quick. In the unlikely event that adequate PES headers are not available, the picture headers could be used instead. In fact, any known information may be useable for detection. Anyway, a one/two CW indication may be stored in the ECM file.

Thus far it has been assumed that a jump in the stream would maximally cross one SCB toggle. If more than one were crossed, the described method might have to be modified. A new scheme for sending ECMs would be needed in such a case. FIG. 18 depicts this situation.

FIG. 18 illustrates jumping across two SCB toggles 1402.

According to the scheme of FIG. 18, an ECM A is sent at the beginning of period A in the frame of stream type I. In the frame of stream type II, at the beginning of period A, ECM B is sent. Furthermore, according to stream type I, ECM C is sent at the beginning of period B, and in the frame of stream type II, ECM D is sent at the beginning of period B.

First of all, a look-ahead can be performed to know whether the next jump will be over one or two SCB toggles 1402. This is necessary to choose the ECM containing the CW to decrypt the data following the next jump as the ECM to be sent to the smartcard. But the data after a two SCB jump is encrypted with the same CW type (odd or even) as the data before the jump. Sending an ECM containing the CW needed after the jump will automatically overwrite the active register in the decrypter with a different value, thus leading to loss of data in the current period. So the method fails and a jump over two SCB toggles is not possible.

This may also be a limiting factor for the maximum trick-play speed. Assuming for a moment that the jump size is at its maximum of one SCB period, then the original time distance of for instance 10 seconds may be compressed to the display time of one trick-play GOP. With IPPP, this may equal 160 ms in Europe. This is a trick-play speed factor of around 60×. Because one is not jumping time but a fixed number of packets, the maximum jump size could translate to for instance 5 seconds. Still the latency or in other words throughput of the smartcard may be the dominating factor that limits the trick-play speed.

In the following, some aspects related to reverse trick-play will be described.

In reverse trick-play, a jump backwards in the stream file is performed. The data belonging to a certain frame is read in forward mode, but as reverse play is created, the next picture read will be a previous picture in the stream.

The way blocks of data may be read and jumps may be made is shown in FIG. 19.

FIG. 19 shows a point of time 1900 at which an ECM A is sent, and shows a point of time 1901 at which an ECM B is sent.

The specific ECM problems are already discussed above for forward trick-play. In the following, it will be discussed what will happen for reverse.

Looking at FIG. 19, the following can be detected:
The CW to decrypt the data from a certain period should already (still) be present in the decrypter when this period is entered.
A previous normal play period (next trick-play period) is always entered during a backward jump.
The ECM holding CW B should be sent when entering period C to allow for the latency of the smartcard at the highest possible trick-play speed.
This ECM then also may hold CW C without any disturbance of the subsequent decryption process of period C (CW C in the decrypter is overwritten by CW C).

So in general, when entering a period in reverse direction, an ECM may be sent that holds the CW of the previous normal play period and that may hold the CW of the period we just entered.

Looking at FIG. 14, it may be seen that when period C is entered in reverse, ECM B has to be sent to the smartcard for stream type I as well as for stream type II. In general, the ECM has to be sent from the period previous to the one entered. Looking at FIG. 19 again, it can also be seen that an SCB toggle 1402 can be crossed more than once and that it is possible to enter a period in reverse twice. For determining at which of these occasions the ECM may be sent, it will be evaluated what happens when entering period C.
If period C is entered a first time, a block of data will be read that extends into period D. To decrypt this block both CW C and CW D should be present in the decrypter registers. At the moment period C is entered for the first time this is indeed the case.
Assuming that ECM B is sent at the moment period C is entered for the first time, then CW B will overwrite CW D in the decrypter register after the latency of the smartcard. If this latency is shorter than the time needed to read and decrypt the block of data, the last part of this block will not be decrypted correctly.
However, when entering period C the second time, CW D is no longer needed because the data block extending across the boundary between periods C and D is already fully decrypted. Therefore, CW B can safely overwrite CW D at this instant. Sending ECM B at this moment is a correct solution.

It can be detected easily that a specific period is going to be entered not only once but also for a second time. The block size in packets, the position in the stream file to which it will be jumped and the position of the SCB toggle 1402 as it is stored in the ECM file are known. If the distance from the jump target to the SCB toggle 1402 is smaller than the block size, the period may be entered a second time.

So in general, an ECM might be sent at the start of the last jump into a period. This is the ECM of the period previous to the one just entered. This is indicated in FIG. 19. It is also possible to say that this ECM may be sent at a jump if the boundary of two periods is located between the ends of the blocks before and after the jump. This may omit the need to detect if the period will be entered twice and may skip the ECM insert for jumps within a period.

In the following, some aspects related to moderate speed forward trick-play will be discussed.

FIG. 16 shows an ideal situation for forward play, where the subsequent data blocks do not overlap. But if the trick-play speed is moderate, that is no I-frames are skipped, some overlap might occur, if the normal play stream is encrypted and the location of the I-frames is unknown.

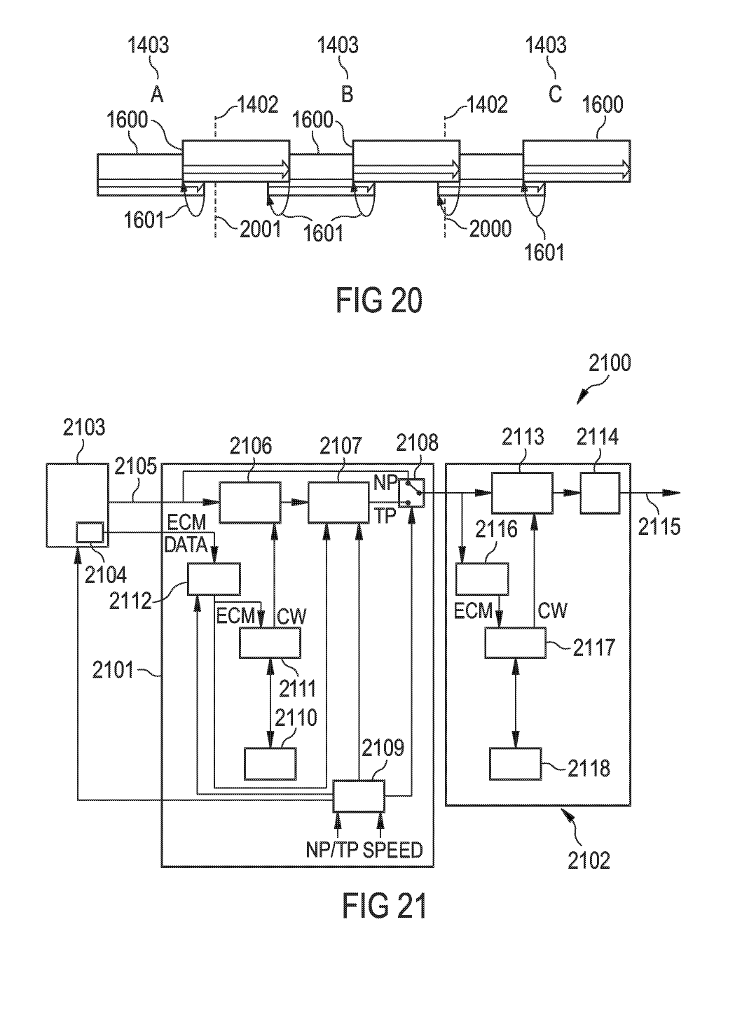

FIG. 20 shows this effect.

Particularly, FIG. 20 shows a point of time 2000 at which an ECM C is sent for stream type I and an ECM D is sent for stream type II, and shows a point of time 2001 at which an ECM B is sent for stream type I and an ECM C is sent for stream type II.

It has been mentioned above that ECMs may be sent at the crossing of an SCB toggle 1402. Now as in reverse it is possible that a specific toggle 1402 is crossed twice in trick-play direction. For identical reasons, the ECM should be sent the last time that the toggle 1402 is crossed. Also here this is easily detectable. Again the block size and the distance between jump targets are known from which it can be derived if jumps backwards are being made. If so and if the known SCB toggle 1402 position is crossed during such backwards jump, this SCB toggle 1402 will be crossed again. For forward trick-play in general, the ECM should be sent the last time a period 1403 is entered. In other words, an ECM may be sent when a new period is entered unless the SCB toggle 1402 is located after the next jump target.

Next, some aspects related to sending the ECMs will be discussed.

In the previous discussion about the handling of ECMs it was mentioned that ECMs have to be sent to the smartcard. Herein, it is described how a plaintext trick-play stream is constructed from a fully encrypted normal play stream. Since it is in plaintext, no ECMs are needed in the MPEG compliant trick-play stream itself but they may be needed to construct it. The trick-play generation, including decrypter, may be part of a storage device. If a smartcard is also present in this device, sending the ECMs could just be what it says, the ECM is sent to the smartcard at the correct moment after transformation into the smartcard interfacing format. But in theory this format may be unknown because the commands to the smartcard may be provider-specific and secret. So the ECM should be sent to the security device to which the smartcard is connected. If no smartcard is present in the storage device itself, some secure communication with an external smartcard, for example in the STB, should be established.

However, for reasons of a more general approach, another option might be preferred in which the necessary ECMs are embedded in the transport stream blocks that are sent to the conditional access module (including the decrypter) for plaintext I-frame extraction. The embedded original ECMs may be removed from this stream. Sending an ECM at a certain moment means that it has to be inserted at that point in the stream to the decrypter. These ECMs could also be regularly repeated as in a normal broadcast signal but this is not really necessary and therefore may complicate the trick-play generation.

In the following, some aspects related to switching between normal play and trick-play will be described.

The switching between normal play and trick-play may result in some special effects. Actual behaviour may depend on the availability of Control Words (CWs) and therefore on the handling and processing of ECMs (Entitlement Control Messages).

Referring to FIG. 21, a trick-play system 2100 will be described.

The trick-play system 2100 includes a storage device 2103, a trick-play generator 2101 and a receiver 2102. The storage device 2103 stores data to be reproduced which are provided as a transport stream 2105 to a decrypter unit 2106 and to a switch unit 2108 of the trick-play generator 2101. The switch unit 2108 may switch between a normal play mode (NP) and a trick-play mode (TP). Via a control unit 2109, the speed of a desired trick-play may be selectively input as well as the fact whether a normal play or a trick-play is desired. This information is provided from the control unit 2109 to the storage device 2103. The control unit 2109 can be, for instance, controlled by a user via a user interface.

Further, the control unit 2109 provides the entered data or commands to a trick-play stream construction unit 2107 and to an ECM memory unit 2112. The storage device 2103 transmits the transport stream not only to the decrypter unit 2106 and to the switch unit 2108, but also provides ECM data stored in an ECM file 2104 to an ECM memory unit 2112. The ECM memory unit 2112, which also receives the parameters from the control unit 2109, provides the trick-play stream construction unit 2107 and a smartcard interface unit 2111 with ECM data. Further, the smartcard interface unit 2111 is adapted to communicate with a smartcard 2110. The smartcard 2110 generates Control Words (CW) and provides the Control Words via the smartcard interface unit 2111 to the decrypter unit 2106.

In a normal play mode, the position of the switch of the switch unit 2108 is as shown in FIG. 21. In this operation mode, the transport stream 2105 is directly provided to the receiver unit 2112. However, when a trick-play mode is selected, the switch will go to the other position, so that the transport stream 2105 will be processed by the trick-play stream construction unit 2107 which will provide trick-play data to the receiver 2102, more particularly to a decrypter unit 2113 of the receiver 2102 and to an ECM extractor unit 2116 of the receiver 2102.

An ECM extractor unit 2116 will supply ECMs to a smartcard interface 2117 that is communicatively coupled to smartcard 2118. In response to the ECMs, the smartcard interface 2117 provides the decrypter unit 2113 with Control Words as decryption information. After having passed the decrypter unit 2113, the data are passed to a decoder/renderer unit 2114 from where the data 2115 may be transmitted to a display unit (not shown).

As depicted in FIG. 21, there are particularly two aspects that have to be considered. The first one is the effect on the receiver 2102 that may decrypt, decode and render a signal that is switched between normal play and trick-play. The second one is the effect of the switching in relation to the trick-play generator 2101.

In the following, the receiver unit 2102 will be further described. The trick-play stream generated according to the techniques described herein may be a plaintext stream. In this case, no decryption of the trick-play stream is necessary in the receiver 2102 and the MPEG decoding can start immediately after the switching to trick-play.

In the following, the trick-play generator 2101 will be further described. The trick-play generator 2101 may decrypt the stream in order to select the plaintext I-frames and construct a trick-play stream from it. This process should start as soon as possible after switching to trick-play. Among others, the number of CWs per ECM influences this. This information is regarded as being known (for instance from the CPI file, see FIG. 4 and corresponding description), because it is also necessary for the continuous trick-play generation.

In the following, a particular scenario of switching from trick-play to normal play will be discussed.

Special effects, which may occur when switching from trick-play to normal play, are described here. Again, it will be distinguished between the trick-play generator 2101 and the receiver 2102.

When switching to normal play, the trick-play generator 2101 can simply stop its operation. So no special measures may be necessary in relation to this trick-play generator. But as will be explained hereafter, the trick-play generator 2101 can improve the switching effects in the receiver 2102 by taking some special actions particularly at this point.

When switching to the encrypted normal play stream, some special effects may occur in the receiver 2102. It might be appropriate to distinguish between two situations, namely the use of individual decrypters or one common decrypter by the receiver 2102 and trick-play generator 2101.

Next, a scenario with individual decrypters will be described.

This situation may occur if receiver 2102 and trick-play generator 2101 are in separate boxes connected via a digital bus, but this configuration can also be used when both are in the same box (see FIG. 21). The switching problem and some solutions are explained hereafter.

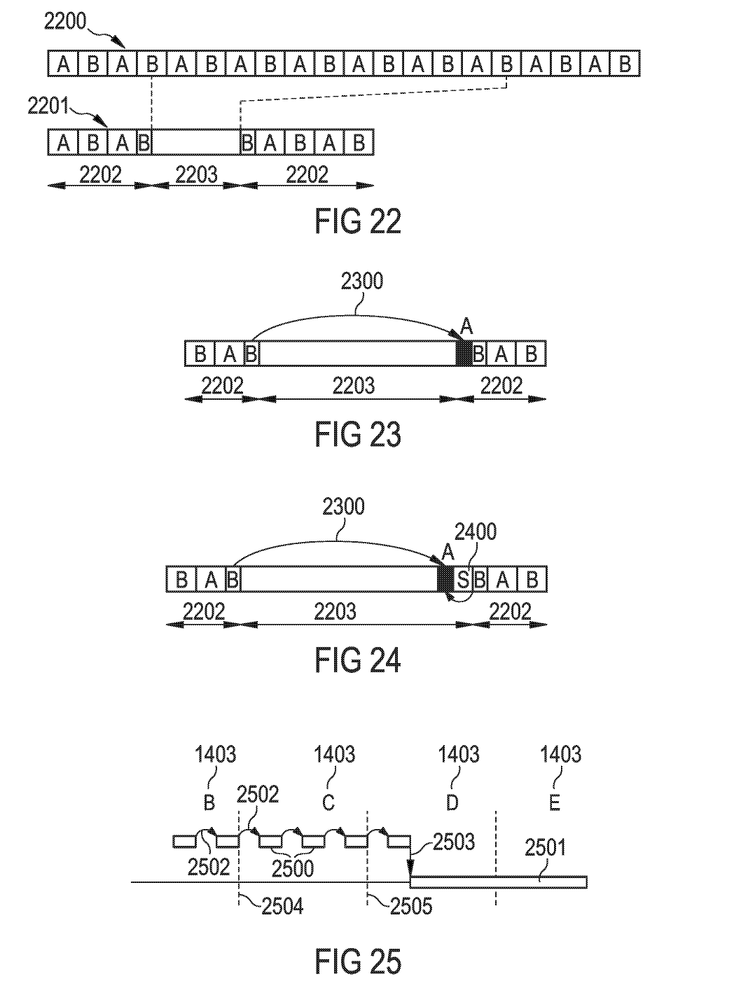

When switching from plaintext trick-play to the encrypted normal play stream, a correct decryption should start as soon as possible. Due to the fact that the ECM stream is interrupted during plaintext trick-play, it could take a while before the user is able to view the normal play video again. This situation is depicted in FIG. 22 for a trick-play speed of 4× forward.

FIG. 22 shows a sequence of periods A and B, wherein A relates to a period with ECMs with table ID 0x80, and B relates to a period with ECMs with table ID 0x81. An upper row 2200 shows a sequence of blocks A and B. A lower row 2201 shows a sequence of blocks A and B with two normal play portions 2202 sandwiching a trick-play portion 2203.

The first ECM after the switching to normal play 2202 might not be extracted from the stream and then forwarded to the smartcard for processing. The same ECM may be transmitted repeatedly, and a toggle in the table ID from 0x80 to 0x81 or vice-versa may indicate the change to a new ECM. To limit the traffic to the smartcard, only the first ECM of a new series as detected from the table ID may be passed on to the smartcard. In the event that the last extracted ECM before switching to trick-play 2203 and the first ECM in the stream after switching back to normal play 2202 are of the same type (both 0x80 or 0x81), this first ECM may be not extracted and processed.

In FIG. 22, the last ECM before and the first ECM after trick-play are both of the B type being ECMs with a table ID of 0x81. Without additional measures it might be required to wait until the next ECM of a different type (A in the example) is encountered which can take long, for instance 10 seconds. During this period, there can be no correct decryption and therefore no MPEG decoding and picture display of the normal play stream 2202.

In the following, four possible solutions for the described problem will be explained.

Solution 1

Some measure may be taken to avoid an excessive switching time from trick-play 2203 to normal play 2202. A first option is to introduce timeout functionality for ECMs in the receiving STB. In a normal situation, ECMs are never further apart than say 800 ms. If no ECMs are present in the stream for several seconds, the STB can be brought into a state where it will send the first encountered ECM to the smartcard. This ensures that the first ECM after plaintext trick-play will be processed. For stream type II, sometimes an additional delay can be introduced when the smartcard is busy. In such a scenario, it may happen that the smartcard is occupied for some time which may obstruct a timely processing of the next ECM.

Solution 2

The storage device that contains the trick-play generator can also force the use of the first ECM of the normal play stream 2202.

This situation is shown in FIG. 23.

The type of the last ECM (0x80 or 0x81) before switching to trick-play (for example fast forward) is remembered. When switching to normal play 2202 again, it may be compared to the type of the first ECM in the normal play stream 2202. If identical, the table ID of the first ECM(s) in the normal play stream 2202 is changed to the other value, making sure that it will be sent to the smartcard by the receiver. An arrow 2300 indicates invert table ID. The additional switching delay may be equal to the above-described solution 1.

Solution 3

In this case, the trick-play generator adds an ECM at the end of the trick-play stream (for example fast forward) at the moment the switching command is received. From the ECM file, the trick-play generator knows what the first ECM of the normal play stream 2202 will be. It then inserts this ECM at the end of the trick-play stream 2203 but with a table ID opposite to the remembered one.

In FIG. 24, the ECM for the first part of the normal play stream 2202 is of type B and the remembered type of the last ECM before trick-play is also B. So the ECM needed to decrypt the normal play stream 2202 directly following trick-play 2203 is taken from the ECM file and inserted at the end of the trick-play stream 2203 but with a table ID changed to A. This ensures that this ECM is sent to the smartcard just before the switching moment. The trick-play generator could insert a still picture 2400 after this ECM for say 0.5 to 1.0 second before really switching to normal play 2202 in order to compensate for the smartcard latency. Although the described example relates to fast-forward, this could also have been fast-reverse.

Solution 4

A fourth option is to have ECMs inserted in the trick-play stream by the trick-play generator. Although not necessary for the processing of the trick-play data by the receiver, it does not disturb this processing either. On the other hand it may prevent the ECM interruption by keeping the ECM stream going.

But what ECM(s) is/are appropriate to be inserted in the trick-play stream? A first possibility is the embedded ECMs present in the original encrypted I-frames that are just copied to the trick-play stream. These ECMs are adequate for forward trick-play. In reverse, strange effects may occur because it is not just an inverted sequence of ECMs. During the I-frame, the ECMs are in a normal forward order but the I-frames are in a reversed order. So it is possible to go back and forth through the table ID toggle, which increases the ECM traffic to the smartcard. At the maximum reverse trick-play speed, the smartcard might not be able to handle this traffic. As a result, it may not always be possible to be sure what the status of the decrypter in the receiver will be when switching to normal play.

An even more logical possibility is that the trick-play generator inserts the ECMs that are used for the trick-play generation. In fact, they are already inserted into the stream to the decrypter of the trick-play generator. So just leaving them in the constructed trick-play stream creates this situation. What will happen now when switching to normal play? Again one might distinguish between forward and reverse.

Next, a transition from forward to normal play will be discussed.

This is depicted in FIG. 25.

FIG. 25 shows a transition 2503 from a forward trick-play mode 2500 (jumps between subsequent data blocks 2500 are illustrated by arrows 2502) to a normal play mode 2501. Particularly, FIG. 25 shows a point of time 2504 at which an ECM C (CW C and CW D) is sent for stream type I, and an ECM D (CW D) is sent for stream type II, and shows a point of time 2505 at which an ECM D (CW D and CW E) is sent for stream type I and an ECM E (CW E) is sent for stream type II.

The sending of ECMs during continuous trick-play forward is such that the decrypter always holds the CW for the current period. The ECM holding the CW for the next period has been sent to the smartcard when crossing into the current period. This CW might still be in the smartcard at the switching moment but it will certainly be available before the end of the current period. The first ECM encountered after the switching to normal play has a table ID that can be different from or identical to the last ECM in the trick-play stream. This depends on the one/two CW situation. It is irrelevant whether this ECM is processed by the smartcard or not because in either case the content of the decrypter registers will not be changed. So wherever the switching point is located in the current period, the decrypter in the receiver will always hold the CW of the current period, and the CW for the next period will certainly be available before crossing into this period. Therefore, the correct decryption of the normal play stream in the receiver may start immediately after the switching to normal play and will not be interrupted.

Next, a transition from reverse to normal play will be discussed.

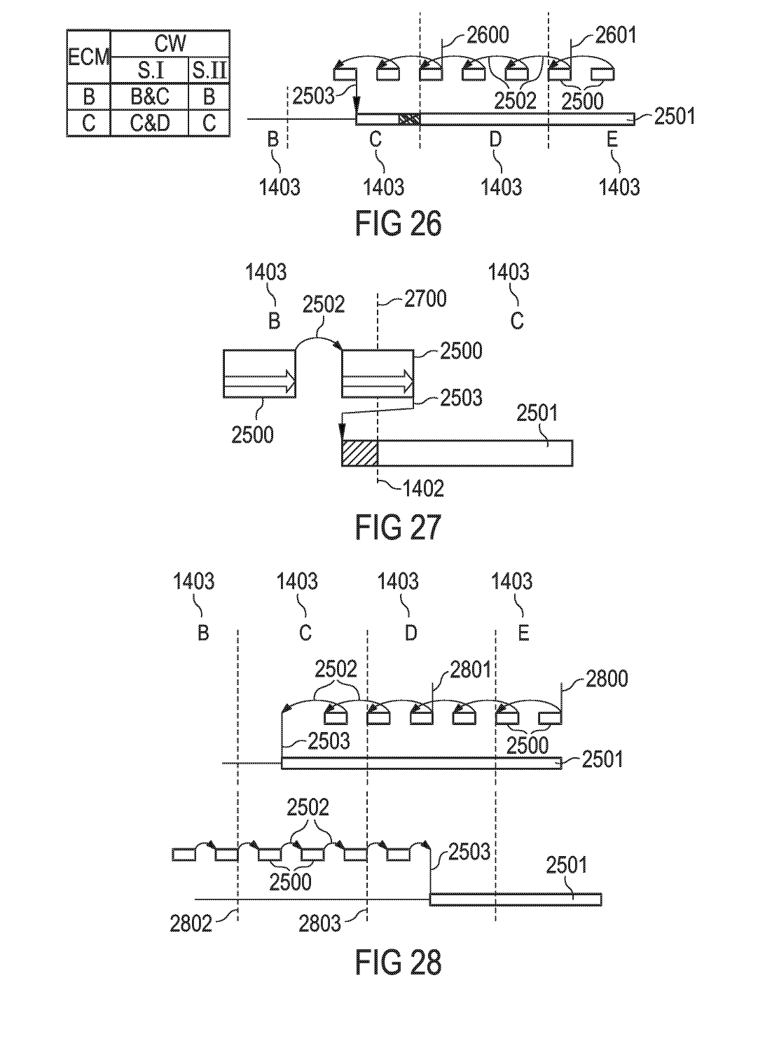

Such a situation is depicted in FIG. 26.

FIG. 26 shows a transition 2503 from a reverse trick-play mode (umps between subsequent data blocks 2500 are illustrated by arrows 2502) to a normal play mode 2501. Particularly, FIG. 26 shows a point of time 2600 at which an ECM B is sent, and shows a point of time 2601 at which an ECM C is sent. Details for stream type I and for stream type II can be taken from a table shown in FIG. 26.

In this case, the CW of the next normal play period will never be available at the switching moment. The decrypter in the receiver will hold the CWs for the current and next trick-play period, but these are the current and previous normal play periods. It is assumed that the transition 2503 takes place somewhere in the middle of the current period C. The last ECM received by the STB before the moment of transition is ECM B of the previous normal play period. The first ECM received after the transition will be an ECM C of the current period. It will be encountered within about 100 ms. As this ECM C has a different table ID than the previous ECM B, it will be passed on to the smartcard and processed. So a correct decryption can start immediately. But this decryption can be interrupted if the switching point is close to the end of a period.

Stream type I may have a gap in the ECMs of close to one second at the end of the period. Switching during this interval means that no ECM C is encountered and that ECM D is the first normal play ECM after the last trick-play ECM being ECM B. Because ECMs B and D have the same table ID, ECM D will not be processed and the normal play stream will be interrupted for a complete period. So the normal play point to which may be jumped should at least be before the gap in the ECMs at the end of the period. If the switching point is in the last second of a period, it may be appropriate to jump back a little in the normal play stream. The effect for stream type II may be more or less identical.

In this case, ECM D may be sent, for instance, already during the last 600 ms of a period. So switching in this interval means that also here ECM C is missed with the same effect as described above. So here it is appropriate to jump to a normal play starting point more than 600 ms before the end of the period. In fact, the same technique can be applied in both cases.

There is yet another effect to be considered. As mentioned above, the remaining normal play time in the current period should allow for the access of an ECM of this period. But additionally it should be sure that this ECM is processed. However, especially at high trick-play speeds, the smartcard might still be busy with the processing of ECM B. During this busy time, incoming ECMs cannot be sent to the smartcard and could very well be discarded. There is no guarantee that they will be buffered for later processing. The time that the smartcard will still be busy may depend on the trick-play speed and the position of the switching point in the period. But in any case it will not be more than the latency of the smartcard. So this latency might be added to the interval of one second discussed above. In general, it is possible to say that the starting point of normal play should minimally be located around two seconds before the end of the current period when switching from reverse to normal play.

In the following, some aspects related to switching delays will be discussed.

An additional switching delay can be introduced by the decryption at the start of the normal play stream. For the above solutions 1 and 2, this delay may be equal to the time until the first ECM is encountered in the normal play stream plus the smartcard delay.

For solution 3, it is only equal to the smartcard delay that is compensated for by the display of a still picture.

Solution 4 does not introduce any switching delay if implemented correctly, but there can be some shift in the starting position of normal play when coming from reverse.

Next, further optimisation of the switching in relation to MPEG will be explained.

In order to have a picture on the screen as fast as possible, there are also effects that are related to the MPEG decoding. Assuming that decryption of the normal play stream can start immediately, it may be appropriate to jump to the start of a GOP for the fastest response of the MPEG decoder. In the case of a stream consisting of only I- and P-frames, the decoding may start with the I-frame being the first one in the GOP and may then continue with the P-frames that are referencing this I-frame. In the case that also B-frames are present in the stream there is a decoding problem due to the reordering of the frames in the transmitted stream (see FIG. 3). The first B-frames encountered in the stream do not belong to the display GOP that started with the first decoded I-frame. In fact they belong to a previous GOP and are not only referencing this I-frame but also a previously transmitted P-frame. This P-frame is not available when replay is started at the start of a transmitted GOP. This leads to an incorrect decoding of these B-frames and thus to corrupted pictures at the start of the normal play stream. In fact, there is no ideal entry point for a transmitted MPEG stream containing B-frames. The best available point is still the start of the I-frame. In the case of a plaintext stream it is possible to clean up the start of the normal play stream by removing the first B-frames located between the I-frame and the next P-frame. However, this may not be possible in the case of an encrypted stream where the locations of the B-frames may not be known.

In order to make the transition on stream level as continuous as possible, the reading of a trick-play data block and the related generation and transmission of a trick-play GOP should be finished before jumping to the normal play stream.

So it may be preferred to finish the trick-play GOP and then jump to the start of a normal play GOP. It might be unknown where this GOP starts, especially with encrypted streams. But in any case the trick-play generator may determine its jump targets in an optimal way. If the start of GOPs is not known, no optimisation with respect to MPEG is possible anyway. If on the other hand the start of GOPs is known from the CPI file they will be used as possible jump targets. Logical points to start normal play are the last trick-play jump target before the switching command is received or the first target after this command.

In the case of the above solutions 1 and 2, a correct decryption of the normal play stream cannot start immediately at the entry point. First, an ECM of the normal play stream itself has to be extracted and processed. This means that the trick-play jump targets cannot be used. Therefore, these solutions are usually not preferred.

Solution 3 will always send the ECM connected to the start of the normal play stream and then wait for the latency of the smartcard. This means that any jump target can be chosen as starting point of the normal play stream. Correct decryption of the normal play stream starts immediately at this point.

Solution 4 has the smallest switching delay from the decryption point of view. In this case, normal play should not be started at the last trick-play jump target before the switching command because this can lead to problems in certain situations.

It may be assumed that at the moment the switching command is received, the end of the data block located on the boundary of periods B and C is reached, as shown in FIG. 27.

FIG. 27 shows a transition 2503 from a forward trick-play mode (umps between subsequent data blocks 2500 are illustrated by arrows 2502) to a normal play mode 2501. Particularly, FIG. 27 shows a point of time 2700 at which an ECM D (CW D) is sent in the case of stream type II, or at which an ECM C (CW C and CW D) is sent in the case of stream type I.

Somewhere at the beginning of period C, the ECM that will overwrite CW B has already been sent to the smartcard at the moment the SCB toggle 1402 has been crossed. Starting normal play 2501 at the last jump target being the start of this same block located in period B leads to an incorrect decryption because CW B is no longer available. On the other hand, if normal play is started at the first jump target after the switching command, this problem does not occur.

In the example, the normal play starting point 2503 is then located in period C meaning that CW B is no longer needed. So in the case of solution 4, normal play may be started at the first jump target after the switching command.

Also when switching from reverse to normal play, some problems with ECMs can occur. But the solution is identical; normal play is started at the first jump target after the switching command. As discussed earlier, the normal play starting point should not be located in the last part of a period in this case. If the envisaged normal play starting point is too close to the end of the period, there are particularly two possible actions:
Select a normal play starting point somewhat earlier in the stream. This point is based on the information in the CPI file, if present.
Continue trick-play until the next jump target is no longer in the last part of a period. Then switch to normal play with this target as a starting point.

FIG. 28 illustrates optimized switching from trick-play 2500 to normal play 2501.

FIG. 28 shows a transition 2503 from a trick-play mode (umps between subsequent data blocks 2500 are illustrated by arrows 2502) to a normal play mode 2501. Particularly, FIG. 28 shows a point of time 2800 at which an ECM C is sent, a point of time 2801 at which an ECM B is sent, a point of time 2802 at which an ECM D is sent in the case of stream type II or at which an ECM C is sent in the case of stream type I, and a point of time 2803 at which an ECM E is sent in the case of stream type II or at which an ECM D is sent in the case of stream type I.

FIG. 28 illustrates optimised switching from trick-play to normal play taking into account decryption and MPEG effects as follows:
When the switching command is received, first finish the current trick-play GOP.
If necessary, continue trick-play reverse until the next jump target is outside the forbidden interval at the end of the period.
Then start normal play at the next trick-play jump target.

As a result of the optimisation of the switching in relation to MPEG, discontinuities in the MPEG stream at the switching moment may be significantly reduced. A first discontinuity is in the PCRs and in the DTS/PTS. These discontinuities can be avoided when switching from normal play to trick-play but due to the compressed time axis in trick-play they cannot be avoided when switching back to normal play. Another discontinuity can be in the continuity counter. Practical decoders may react to all these discontinuities. In any case it may be appropriate that they are signalled to the decoder as much as possible. If the trick-play generator and decoder are in one box this can be fairly easy but otherwise the possibilities offered by the MPEG standard may be used.

When switching between trick-play and normal play, there can also be a problem related to the Service Information (SI) tables that are in the stream. It is relatively probable that at least some tables will be split over multiple packets. This also means that one can switch when a table is only partly received/processed. The mandatory tables PAT (Program Association Table), CAT (Conditional Access Table) and PMT (Program Map Table) are created by the trick-play engine and embedded in the trick-play stream. Other tables are not transmitted during trick-play.

When switching to trick-play, discontinuities can be avoided by some synchronisation between the trick-play engine and normal play. When switching back to normal play, the trick-play engine cannot ensure the absence of discontinuities. The PAT/CAT/PMT tables are complete within a trick-play GOP. Because the trick-play GOP is completed before switching to normal play, no incomplete tables are present at the end of the trick-play stream. But it is not known where to jump into the normal play stream in relation to the tables. So the first table packets encountered after the switch might only contain the last part of a table. It is not known how an STB reacts to this but in fact it may be expected that such a packet will be discarded because a table header is needed for the parsing of the table. Thus, when acting as described, there might not be a real problem.

Actually, all tables except PAT/CAT/PMT should be removed from a recorded partial transport stream and a SIT (Selection Information Table) and DIT (Discontinuity Association Table) should be inserted, the SIT containing all relevant SI data. The DIT signals a discontinuity and could (should) be inserted at the switching point. A box accepting a partial TS should understand the meaning of a DIT when it is present. In the DVB standard, it is claimed: Whenever a partial bit-stream discontinuity occurs, two transport stream packets belonging to PID 0x001E (DIT) shall be inserted directly at the transition point, with no other packets in between. The first one shall have 184 bytes of adaptation field stuffing with discontinuity flag set to “1” (in order to ensure compliance to MPEG-2 continuity counting constraints for successions of transitions introduced at independent transmission/storage stages). The second of these transport packets shall contain the “DIT” and shall not have such a flag set to “1”.

Next, an embodiment having a common decrypter will be described.

The use of one common decrypter by receiver and trick-play generator can be the case when receiver and trick-play generator are combined in one box. There is no sharing violation because this decrypter is only used by the trick-play generator during trick-play and by the receiver in normal play.

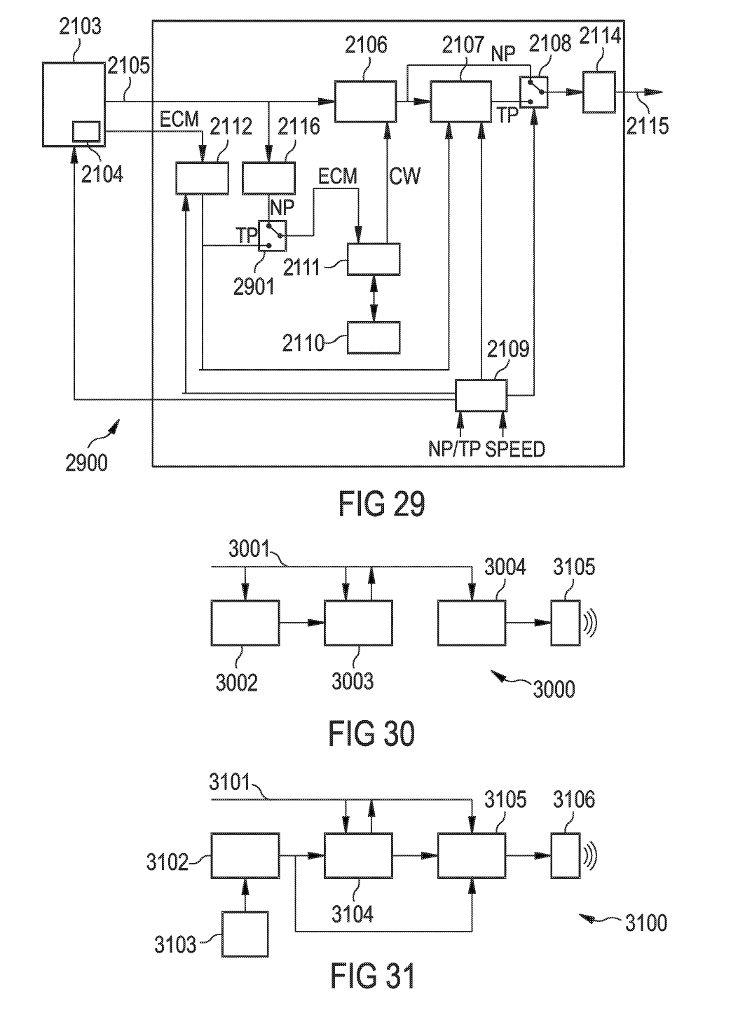

FIG. 29 shows a system 2900 with a common decrypter 2106, wherein most of the components are denoted with reference numerals according to the corresponding functional elements of the system 2100 of FIG. 21. However, an additional switch 2901 is provided in the system 2900 with the common decrypter 2106.

From a switching point of view, the situation for one common decrypter 2106 is identical to the situation for two synchronized individual decrypters. This is in fact the case for solution 4 described previously for two individual decrypters. Solutions 2 and 3 might also be used, but for one common decrypter 2106, the ECM traffic is not interrupted during trick-play. So the memorized table ID should not be the one of the last normal play ECM but from the last ECM sent to the decrypter before the special switching ECM. This is the table ID of the last normal ECM of the trick-play stream. Problems with a busy smartcard can be avoided by the choice of the switching moment. So most of what is described for two individual decrypters is also applicable here.

In the following, referring to FIG. 30, a device 3000 for processing an encrypted data stream 3001 according to an exemplary embodiment of the invention will be described.

Decryption messages, namely ECMs, are provided for decrypting each period 1403 of the encrypted data stream 3001, wherein each ECM comprises a number of Control Words (CW) as decryption elements.

The device 3000 comprises a detection unit 3002 for detecting the number of Control Words per Entitlement Control Message (ECM). This number is two for stream type I, and is one for stream type II. The encrypted data stream 3001 may be supplied to the detection unit 3002.

The device 3000 further comprises a determining unit 3003 for determining a position for providing the ECMs in the sequence of the periods 1403, based on the detected number. For this purpose, the output of the detection unit 3002 which may encode a number of Control Words per ECM, may be supplied to the determining unit 3003. Further, the determining unit 3003 may be supplied with the encrypted data stream 3001 and may modify the encrypted data stream 3001 accordingly, to properly position or insert the ECMs.

The (original or modified) encrypted data stream may be provided to a generation unit 3004 which may decrypt the encrypted data stream 3001 to provide the latter for a normal play mode and reproduce it via a reproduction unit 3005, or may alternatively generate a trick-play stream from the encrypted data stream 3001, in order to perform trick-play on the reproduction unit 3005.

When the detection unit 3002 detects that an ECM corresponding to a particular period 1403 includes two Control Words per ECM (stream type I), then the determining unit 3003 may provide the ECM zero segments in advance. Alternatively, when the detecting unit 3002 detects that the number of Control Words of an ECM is one, then the determining unit 3003 may provide the ECM one period 1403 in advance (stream type II).

In the following, referring to FIG. 31, a device 3100 for processing an encrypted data stream 3101 according to another exemplary embodiment of the invention will be described.

Again, ECMs as decryption messages may be provided for decrypting each period 1403 of the encrypted data stream 3101.

The device 3100 comprises a detection unit 3102 for detecting a switch from a trick-play reproduction mode (for instance a fast forward mode) to a normal play reproduction mode. A user may initiate such a switch by operating a user interface 3103, for instance by pressing a corresponding button.

In such an event, the detection unit 3102 transmits this information to a determining unit 3104 and to a generation unit 3105.

The determining unit 3104 is adapted to ensure, based on a comparison of a last ECM before the trick-play reproduction mode and a first ECM in the normal play reproduction mode, that the first ECM in the normal play reproduction mode is sent to a smartcard. The determining unit 3104 may modify the encrypted data stream 3101 accordingly.

Further, the generation unit 3105 is capable of generating, selectively, a trick-play reproduction stream or normal play reproduction stream to be reproduced by a reproduction unit 3106. For this purpose, the generation unit 3105 is provided with the encrypted data stream 3101, and may receive controlling information from the detection unit 3102 and/or from the determining unit 3104.

The determining unit 3104 may be adapted to determine whether the first ECM in the normal play reproduction mode is to be processed to avoid an excessive interruption of a reproduction when switching from the trick-play generation mode to the normal play mode.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1-38. (canceled)

39. A device (3000) for processing an encrypted data stream (3001), wherein decryption messages are provided for decrypting each segment (1403) of the encrypted data stream (3001),
wherein each decryption message comprises a number of decryption elements,
wherein the device (3000) comprises
a determining unit (3003) for determining a position for providing the decryption messages in relation to the sequence of the segments (1403),
characterized in that the device further comprises
a detection unit (3002) for detecting the number of decryption elements per decryption message, the number of decryption messages being indicative of the position to be determined;
wherein the determining unit (3003) further determines the position for providing the decryption messages in relation to the sequence of the segments (1403), based on the detected number of decryption elements per decryption message.

40. The device (3000) according to claim 39,
wherein the decryption messages are Entitlement Control Messages and the decryption elements are Control Words.

41. The device (3000) according to claim 39,
wherein a decryption message corresponding to a particular segment (1403) is provided in advance of the particular segment (1403).

42. The device (3000) according to claim 39, wherein
the encrypted data stream is of a first type of encrypted data stream (1400) or the encrypted data stream is of a second type of encrypted data stream (1401);
the first type of encrypted data stream comprising a first number of decryption elements per decryption message which is equal to the number of decryption messages; and
the second type of encrypted data stream comprising a second number of decryption elements per decryption message which is not equal to the number of decryption messages;
the detection unit is further arranged to detect the first number of decryption elements per decryption message for the first type of encrypted data stream or to detect the second number of decryption elements per decryption message for the second type of encrypted data stream; and
the determining unit (3003) is further arranged to determine the position for providing the decryption messages in relation to the sequence of the segments (1403), based on the first number of decryption elements per decryption message for the first type of encrypted data stream or based on the second number of decryption elements per decryption message for the second type of encrypted data stream.

43. The device (3000) according to claim 39,
wherein the determining unit (3003) is adapted to, in case that the detected number of decryption elements per decryption message is two, provide the decryption message directly preceding the corresponding segment (1403).

44. The device (3000) according to claim 39,
wherein the determining unit (3003) is adapted to, in case that the detected number of decryption elements per decryption message is one, provide the decryption message one segment (1403) in advance.

45. The device (3000) according to claim 39,
comprising a storage unit adapted to store the decryption messages in a separate file.

46. The device (3000) according to claim 45,
wherein the file is indicative of the assignment of each of the decryption messages to the corresponding segments (1403).

47. The device (3000) according to claim 43,
comprising two registers (1501, 1502) for storing the two decryption elements assigned to a decryption message, wherein, at a time, only one of the two registers is capable of overwriting data stored therein.

48. The device (3000) according to claim 44,
comprising two registers (1501, 1502) for storing decryption elements, wherein, at a time, only one of the two registers is capable of overwriting data stored therein.

49. The device (3000) according to claim 39,
comprising a control unit adapted to remove originally provided decryption messages from the encrypted data stream (3001).

50. The device (3000) according to claim 39,
adapted to process an encrypted data stream (3001) of video data or audio data.

51. The device (3000) according to claim 39,
adapted to process an encrypted data stream (3001) of digital data.

52. The device (3000) according to claim 39,
comprising a reproduction unit (3005) for reproducing the decrypted data stream.

53. The device (3000) according to claim 39,
comprising a generation unit (3004) for processing the data stream for reproduction in a trick-play reproduction mode.

54. The device (3000) according to claim 53,
wherein the trick-play reproduction mode is one of the group consisting of a fast forward reproduction mode, a fast reverse reproduction mode, a slow motion reproduction mode, a freeze frame reproduction mode, an instant replay reproduction mode, and a reverse reproduction mode.

55. The device (3000) according to claim 39,
adapted to process an encrypted MPEG2 data stream (3001).

56. The device (3000) according to claim 39,
realized as at least one of the group consisting of a digital video recording device and a network-enabled device and a conditional access system and a portable audio player and a portable video player and a mobile phone and a DVD player and a CD player a harddisk-based media player and an internet radio device and a public entertainment device and an MP3 player.

57. A method of processing an encrypted data stream (3001), wherein decryption messages are provided for decrypting each segment (1403) of the encrypted data stream (3001), wherein each decryption message comprises a number of decryption elements,
wherein the method comprises the steps of
determining a position for providing the decryption messages in relation to the sequence of the segments (1403)
characterized in that the method further comprises
detecting the number of decryption elements per decryption message, the number of decryption messages being indicative of the position to be determined; and
wherein the step of determining further determines the position for providing the decryption messages in relation to the sequence of the segments (1403), based on the detected number of decryption elements per decryption message.

58. A computer-readable medium, in which a computer program of processing an encrypted data stream (3001), wherein decryption messages are provided for decrypting each segment (1403) of the encrypted data stream (3001), wherein each decryption message comprises a number of decryption elements, is stored, which computer program, when being executed by a processor, is adapted to control or carry out the following method steps:
determining a position for providing the decryption messages in relation to the sequence of the segments (1403)
characterized in that the method further comprises
detecting the number of decryption elements per decryption message, the number of decryption messages being indicative of the position to be determined; and
wherein the step of determining further determines the position for providing the decryption messages in relation to the sequence of the segments (1403), based on the detected number of decryption elements per decryption message.

59. A program element of processing an encrypted data stream (3001), wherein decryption messages are provided for decrypting each segment (1403) of the encrypted data stream (3001), wherein each decryption message comprises a number of decryption elements, which program element, when being executed by a processor, is adapted to control or carry out the method steps of:
determining a position for providing the decryption messages in relation to the sequence of the segments (1403)
characterized in that the method further comprises
detecting the number of decryption elements per decryption message, the number of decryption messages being indicative of the position to be determined; and
wherein the step of determining further determines the position for providing the decryption messages in relation to the sequence of the segments (1403), based on the detected number of decryption elements per decryption message.
